(19) United States
(12) Patent Application Publication
(10) Pub. No.: US 2023/0155800 A1
(43) Pub. Date: May 18, 2023

(54) SPATIAL PARAMETER CAPABILITY INDICATION

(71) Applicant: Lenovo (Singapore) PTE. LTD., New Tech Park (SG)

(72) Inventors: Majid Ghanbarinejad, Chicago, IL (US); Vijay Nangia, Woodridge, IL (US); Hyejung Jung, Northbrook, IL (US)

(21) Appl. No.: 17/916,713

(22) PCT Filed: Apr. 1, 2021
(86) PCT No.: PCT/IB2021/052760

§ 371 Date: Oct. 3, 2022

Related U.S. Application Data
(60) Provisional application No. 63/004,215, filed on Apr. 2, 2020.

(51) Int. Cl. H04L 5/00

(52) U.S. Cl. CPC H04L 5/0092; H04L 5/0053

(57) ABSTRACT

Apparatuses, methods, and systems are disclosed for spatial parameter capability indication. One method (1600) includes receiving (1602), at a first wireless node, a first control message from a second wireless node. The first control message includes a first indication of a first resource and a first spatial indication. The method (1600) includes determining (1604) whether a second resource overlaps with the first resource in a time domain and whether a reception time of the first control message is not later than a time threshold. The method (1600) includes transmitting (1606) a second control message to a third device. The second control message includes a second indication of a second resource and a second spatial indication indicating that the first wireless node is capable of simultaneously applying a first spatial parameter and a second spatial parameter.

### CROSS-REFERENCE TO RELATED APPLICATIONS

This application claims priority to U.S. Patent Application Ser. No. 63/004,215 entitled “APPARATUSES, METHODS, AND SYSTEMS FOR BEAM MANAGEMENT FOR INTEGRATED ACCESS AND BACKHAUL WITH MULTIPLE ANTENNAS” and filed on Apr. 2, 2020 for Majid Ghanbarinejad, which is incorporated herein by reference in its entirety.

### FIELD

The subject matter disclosed herein relates generally to wireless communications and more particularly relates to spatial parameter capability indication.

### BACKGROUND

In certain wireless communications networks, capability information may need to be provided to devices. In such networks, the capability information may need to be provided within a certain time period to be used.

### BRIEF SUMMARY

Methods for spatial parameter capability indication are disclosed. Apparatuses and systems also perform the functions of the methods. One embodiment of a method includes receiving, at a first wireless node, a first control message from a second wireless node, wherein the first control message comprises a first indication of a first resource and a first spatial indication. In some embodiments, the method includes determining whether a second resource overlaps with the first resource in a time domain and whether a reception time of the first control message is not later than a time threshold. In various embodiments, the method includes, in response to the second resource overlapping with the first resource in the time domain and the reception time of the first control message not being later than the time threshold, transmitting a second control message to a third device, wherein the second control message comprises a second indication of a second resource and a second spatial indication indicating that the first wireless node is capable of simultaneously applying a first spatial parameter in accordance with the first spatial indication and a second spatial parameter in accordance with the second spatial indication.

One apparatus for spatial parameter capability indication includes a receiver that receives, at a first wireless node, a first control message from a second wireless node, wherein the first control message comprises a first indication of a first resource and a first spatial indication. In various embodiments, the apparatus includes a processor that determines whether a second resource overlaps with the first resource in a time domain and whether a reception time of the first control message is not later than a time threshold. In some embodiments, the apparatus includes a transmitter that, in response to the second resource overlapping with the first resource in the time domain and the reception time of the first control message not being later than the time threshold, transmits a second control message to a third device, wherein the second control message comprises a second indication of a second resource and a second spatial indication indicating that the first wireless node is capable of simultaneously applying a first spatial parameter in accordance with the first spatial indication and a second spatial parameter in accordance with the second spatial indication.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for spatial parameter capability indication;

FIG. 2 is a schematic block diagram illustrating one embodiment of an apparatus that may be used for spatial parameter capability indication;

FIG. 3 is a schematic block diagram illustrating one embodiment of an apparatus that may be used for spatial parameter capability indication;

FIG. 4 is a diagram illustrating one example of an integrated access and backhaul (“IAB”) system;

FIG. 5 is a flowchart diagram illustrating one embodiment of a QCL indication;

FIG. 6 is a diagram illustrating another embodiment of an JAB system;

FIG. 7 is a diagram illustrating yet another embodiment of an JAB system;

FIG. 8 is a diagram illustrating a further embodiment of an JAB system;

FIG. 9 is a schematic block diagram illustrating one embodiment of a wireless channel between a multi-panel node, its parent node, and its child node;

FIG. 10 is a flowchart diagram illustrating one embodiment of an early dynamic TCI state indication;

FIG. 11 is a timing diagram illustrating one embodiment of a timeline for early dynamic TCI state indication for a resource set;

FIG. 12 is a timing diagram illustrating one embodiment of a timeline for early dynamic TCI state indication for a channel;

FIG. 13 is a timing diagram illustrating one embodiment of multi-hop delay for TCI state indications;

FIG. 14 is a flowchart diagram illustrating one embodiment of a semi-static TCI state configuration;

FIG. 15 is a timing diagram illustrating one embodiment of a timeline for semi-static TCI state configuration; and

FIG. 16 is a flow chart diagram illustrating one embodiment of a method for spatial parameter capability indication.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

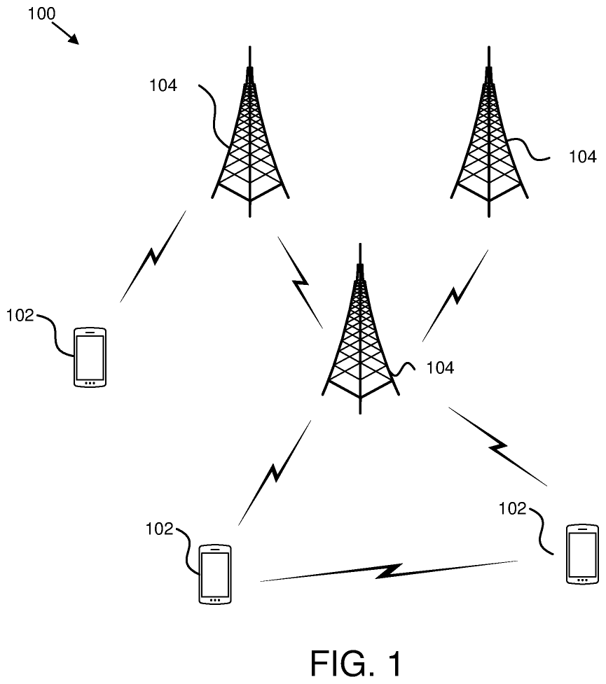

FIG. 1 depicts an embodiment of a wireless communication system 100 for spatial parameter capability indication. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 and/or a network unit 104 may receive, at a first wireless node, a first control message from a second wireless node, wherein the first control message comprises a first indication of a first resource and a first spatial indication. In some embodiments, the remote unit 102 and/or the network unit 104 may determine whether a second resource overlaps with the first resource in a time domain and whether a reception time of the first control message is not later than a time threshold. In various embodiments, the remote unit 102 and/or the network unit 104 may, in response to the second resource overlapping with the first resource in the time domain and the reception time of the first control message not being later than the time threshold, transmit a second control message to a third device, wherein the second control message comprises a second indication of a second resource and a second spatial indication indicating that the first wireless node is capable of simultaneously applying a first spatial parameter in accordance with the first spatial indication and a second spatial parameter in accordance with the second spatial indication. Accordingly, the remote unit 102 and/or the network unit 104 may be used for spatial parameter capability indication.

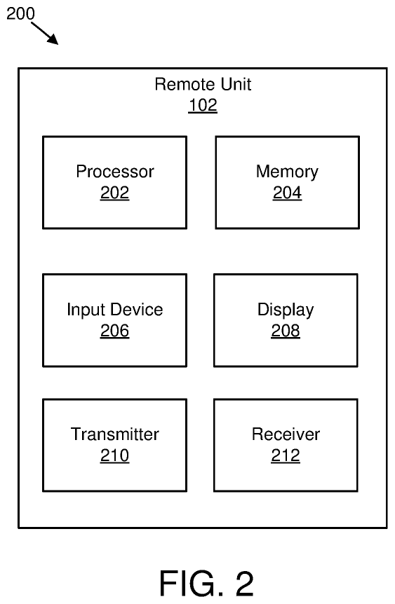

FIG. 2 depicts one embodiment of an apparatus 200 that may be used for spatial parameter capability indication. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 receives, at a first wireless node, a first control message from a second wireless node, wherein the first control message comprises a first indication of a first resource and a first spatial indication. In various embodiments, processor 202 determines whether a second resource overlaps with the first resource in a time domain and whether a reception time of the first control message is not later than a time threshold. In some embodiments, the transmitter 210, in response to the second resource overlapping with the first resource in the time domain and the reception time of the first control message not being later than the time threshold, transmits a second control message to a third device, wherein the second control message comprises a second indication of a second resource and a second spatial indication indicating that the first wireless node is capable of simultaneously applying a first spatial parameter in accordance with the first spatial indication and a second spatial parameter in accordance with the second spatial indication.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

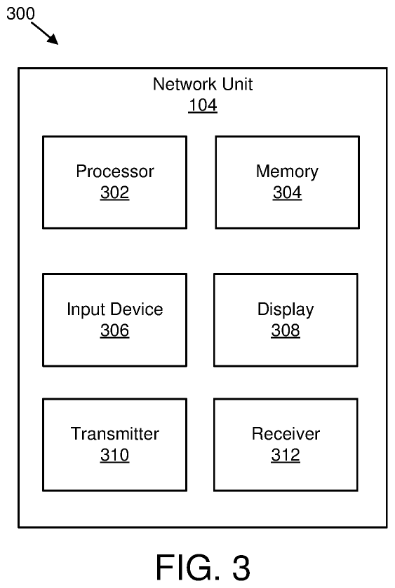

FIG. 3 depicts one embodiment of an apparatus 300 that may be used for spatial parameter capability indication. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 receives, at a first wireless node, a first control message from a second wireless node, wherein the first control message comprises a first indication of a first resource and a first spatial indication. In various embodiments, processor 302 determines whether a second resource overlaps with the first resource in a time domain and whether a reception time of the first control message is not later than a time threshold. In some embodiments, the transmitter 310, in response to the second resource overlapping with the first resource in the time domain and the reception time of the first control message not being later than the time threshold, transmits a second control message to a third device, wherein the second control message comprises a second indication of a second resource and a second spatial indication indicating that the first wireless node is capable of simultaneously applying a first spatial parameter in accordance with the first spatial indication and a second spatial parameter in accordance with the second spatial indication.

In certain embodiments, IAB may relate to a specific multiplexing and duplexing scheme and/or time-division multiplexing (“TDM”) between upstream communications (e.g., with a parent IAB node and/or donor) and downstream communications (e.g., with a child IAB node or a UE).

In some embodiments, IAB may operate in a flexible time division duplex (“TDD”) mode. In such embodiments, each slot may be configured semi-statically to contain downlink (“DL” and/or “D”) symbols, uplink (“UL” and/or “U”) symbols, and flexible (“F”) symbols. Each flexible symbol may be configured to be a DL symbol or an UL symbol at an instance. The DL, UL, and/or F configurations may follow an UL-F-DL pattern (e.g., they may start with UL symbols and end with DL symbols) thereby providing flexibility over configurations that only follow a DL-F-UL pattern.

In various embodiments, in an IAB system, resources may be configured as hard (“H”) or soft (“S”), or if not H or S the resources may be considered not available (“NA”). In such embodiments, hard resources may be always available for scheduling communications with a UE or a child node; soft resources may be possibly available which may be indicated by DCI signaling; and NA symbols may not be available to an IAB node for scheduling its own communications with a UE or a child node (however, this does not mean that the IAB node may not communicate with its parent node using the NA symbols, perform measurements on the NA symbols, and so forth).

In certain embodiments, D, U, F, H, S, and/or NA attributes may be per OFDM symbol (e.g., the granularity for resource configuration with these attributes may be all available frequency resources (e.g., in the active bandwidth part) on time resources as short as one OFDM symbol). In such embodiments, if soft resources are to be indicated available or not available by DCI signaling, the granularity for availability indication (“AI”) may be a resource type in terms of D, U, and/or F per slot. That is, all symbols that are configured D, L, or F in a slot are indicated available or not available. This may indicate a coarser granularity (e.g., essentially all frequency resources on one or several OFDM symbols).

In some embodiments, if uplink and/or upstream and downlink and/or downstream transmissions are not always scheduled in separate time intervals, there may be potential issues with beam management. For example, an IAB node with multiple antenna panels may operate at a frequency range 2 (“FR2”), and each antenna panel may be suitable for communications with a parent IAB node, a child IAB node, or a user equipment (“UE”). In various embodiments, if scheduling communications with an IAB node, a parent node may select an antenna panel and/or a beam via a transmission configuration indication (“TCI”). In certain embodiments, if one panel is selected for communications with a parent node, another panel may be used for communications with a child node or a UE. In such embodiments, it may be important for an IAB node to be informed sufficiently in advance about which of the antenna panels are to be used for communications with the parent node.

In various embodiments, such as in mobile IAB systems in which IAB nodes are installed on top of public transit vehicles, a “best” panel for communication with another node (e.g., including a parent node, a child node, or a UE) may change frequently.

In certain embodiments, such as in multiuser systems in which an IAB node serve different subsets of child nodes at different times, the IAB node may select a different panel for one communication with a child node than for another communication with the same child node.

In some embodiments, beam management and spatial-division multiplexing (“SDM”) may be used for IAB systems.

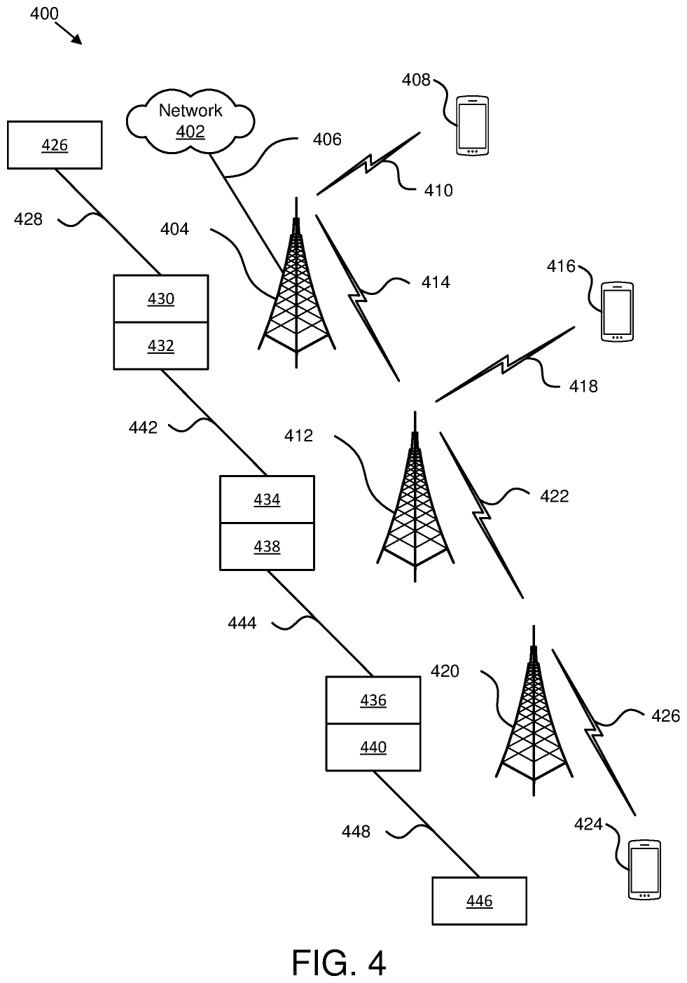

FIG. 4 is a diagram illustrating one embodiment of an IAB system 400. The IAB system 400 includes a network 402 (e.g., core network) that communicates with an IAB donor 404 via a first communication link 406. Moreover, the IAB system 400 also includes a first UE 408 that communicates with the IAB donor 404 via a second communication link 410. Further, the IAB system 400 includes a first IAB node 412 that communicates with the IAB donor 404 via a third communication link 414. The IAB system 400 also includes a second UE 416 that communicates with the first IAB node 412 via a fourth communication link 418. Moreover, the IAB system 400 includes a second IAB node 420 that communicates with the first IAB node 412 via a fifth communication link 422. Further, the IAB system 400 includes a third UE 424 that communicates with the second JAB node 420 via a sixth communication link 426.

As illustrated in further detail, a network 426 is connected to the IAB donor 404 through a backhaul link 428, which may be wired. The IAB donor 404 includes a CU (IAB-CU) 430 and a DU (IAB-DU) 432. The IAB donor 404 communicates with all the DUs in the system through an F1 interface. Each JAB node (e.g., 412 and 420) is functionally split into at least an MT (IAB-MT) (e.g., 434, 436) and a DU (IAB-DU) (e.g., 438, 440). An MT of an JAB node is connected to a DU of a parent node, which may be another JAB node or the IAB donor 404.

A wireless connection (e.g., 414, 422, 426, 442, 444) between an MT of an JAB node and a DU of a parent node, which may be a Uu link, is called a wireless backhaul link. In the wireless backhaul link, in terms of functionalities, the MT is similar to a UE and the DU of the parent node is similar to a base station in a conventional cellular wireless link. Therefore, a link from an MT to a serving cell that is a DU of a parent link is called an uplink, and a link in the reverse direction is called a downlink. In this disclosure, embodiments may simply refer to an uplink or a downlink between JAB nodes, a link between a node and its parent, a link between a node and its child, and so forth without a direct reference to an MT, DU, serving cell, and so forth.

Each IAB donor or JAB node may serve UEs (e.g., 446) through access links (e.g., 448). JAB systems like JAB system 400 may be designed to enable multi-hop communications (e.g., a UE may be connected to the core network through an access link and multiple backhaul links between JAB nodes and an IAB donor). As used herein, unless stated otherwise, an “IAB node” may generally refer to an JAB node or an IAB donor as long as a connection between a CU and a core network is not concerned.

A node, link, etc. closer to an IAB donor and/or core network may be called an upstream node, link, etc. For example, a parent node of a subject node is an upstream node of the subject node and the link to the parent node is an upstream link with respect to the subject node. Similarly, a node, link, etc. farther from the IAB donor and/or core network is called a downstream node, link, etc. For example, a child node of a subject node is a downstream node of the subject node and the link to the child node is a downstream link with respect to the subject node.

Table 1 summarizes terminology used herein.

TABLE 1
Terminology

| Phrase | Description |
|---|---|
| Wireless backhaul link | A connection between an MT of an IAB node and a DU of a serving cell |
| Wireless access link | A connection between a UE and (a DU of) a serving cell |
| IAB-node | RAN node that supports NR access links to UEs and NR backhaul links |
| | to parent nodes and child nodes. |
| IAB-MT | IAB-node function that terminates the Uu interface to the parent node |
| IAB-DU | gNB-DU functionality supported by the IAB-node to terminate the NR |
| | access interface to UEs and next-hop IAB-nodes, and to terminate the F1 |
| | protocol to the gNB-CU functionality on the IAB-donor |
| IAB-donor | gNB that provides network access to UEs via a network of backhaul and |
| | access links. |
| Parent [IAB] node | An IAB node or IAB donor that comprises a serving cell of the subject |
| | node. In some examples, IAB-node-MT's next hop neighbour node; the |
| | parent node can be IAB-node or IAB-donor-DU. |
| Child [IAB] node | An IAB node that identifies the subject node as a serving cell. In some |
| | examples, IAB-node-DU's next hop neighbour node; the child node is |
| | also an IAB-node. |
| Sibling [IAB] node | An IAB node that has a common parent with the subject node |
| Uplink (of a wireless backhaul link) | A link from an MT to a DU of a parent node |
| Downlink (of a wireless backhaul | A link from a DU to an MT of a child node |
| link) | |
| Upstream node/link/etc. | A node, link, etc. (topologically) closer to the IAB donor and/or core |
| | network. Direction toward parent node in IAB-topology |
| Downstream node/link/etc. | A node, link, etc. (topologically) farther from the IAB donor and/or core |
| | network. Direction toward child node or UE in IAB-topology |

In various embodiments, for timing alignment, inter-node discovery and measurements, resource allocation enhancements, and/or other features, a wireless backhaul link at a physical layer may be used.

In certain embodiments, for beam management for a UE in RRC_CONNECTED mode, the following may be performed: beam acquisition and maintenance, beam indication, and/or beam failure recovery.

In some embodiments, following a beam-based initial access that enables a UE to establish an RRC connection with a gNB, the gNB may configure beam acquisition and maintenance procedures through RRC signaling for the UF.

In various embodiments, a UE may be configured with M resource settings. Each of the M resource settings may be configured by a CSI-ResourceConfig IE, and N reporting settings may be configured by a CSI-ReportConfig IE. The UE may perform measurements on reference signals (e.g., CSI-RS or SS/PBCH blocks) transmitted by the gNB on the configured resources indicated by field of type CSI-ResourceConfigId in a reporting setting to produce the associated report. The timing of producing and transmitting a report may be controlled by a network through physical layer, MAC layer, and/or RRC signaling. Moreover, a periodic report may be produced and transmitted as configured by RRC signaling, a semi-persistent report may be activated and/or deactivated by MAC signaling, and an aperiodic report may use triggering by a downlink control information (“DCI”) message.

In certain embodiments, if a gNB intends to indicate a beam for communications, the gNB may use a transmission configuration indication (“TCI”) parameter which may indicate a quasi-collocation (“QCL”) between a reference signal resource (e.g., a CSI-RS resource or an SS/PBCH block resource) and a DM-RS of the upcoming communication. A QCL indication of ‘Type D’ may indicate that a UE is expected to use the same beam it has used for receiving and/or transmitting the reference signal to receive and/or transmit the upcoming communication.

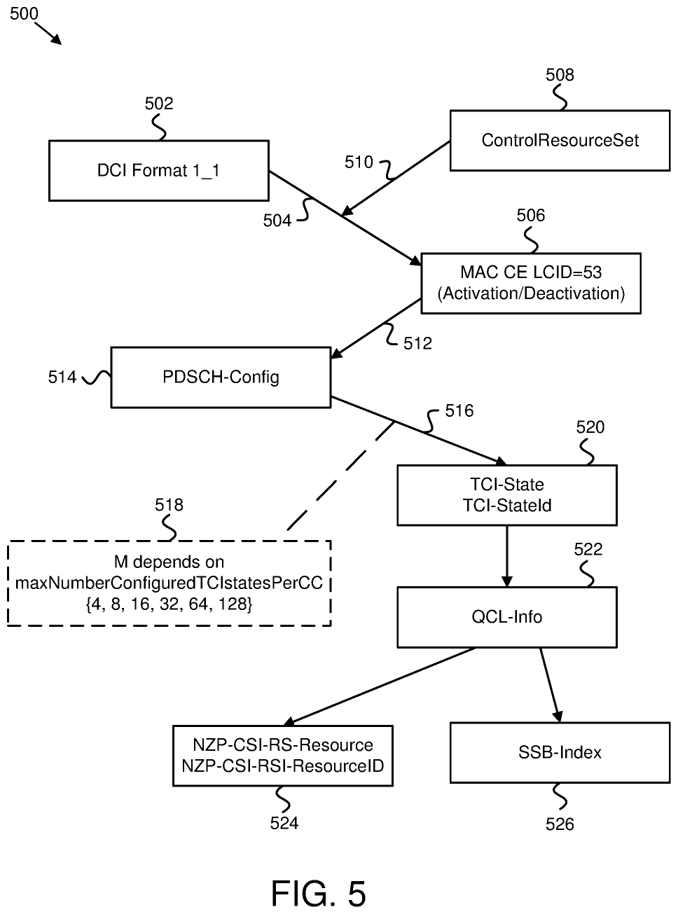

FIG. 5 illustrates one embodiment of how DCI format 1_1 may indicate QCL to a CSI-RS resource ID or an SSB index.

FIG. 5 is a flowchart diagram 500 illustrating one embodiment of a QCL indication. The flowchart diagram 500 illustrates a DCI format 1_1 502 including a TCI 604 (3-bits) provided to a MAC CE 506 used for activation and/or deactivation (e.g., logical channel identifier (“LCID”)=53). A ControlResourceSet 508 may provide tci-PresentInDCI 510 with the TCI 504 to the MAC CE 506. The MAC CE 506 may provide a bitmap 512 (e.g., up to 8 bits) to a PDSCH-Config 514. Moreover, the PDSCH-Config 514 may provide up to M 516 resource settings (e.g., M may depend on maxNumberConfiguredTCIstatesPerCC 518 {4, 8, 16, 32, 64, 128} for a TCI-State 520 (e.g., having a TCI-StateID). The TCI-State 520 may be provided to QCL-Info 522, which may indicate an NZP-CSI-RS-Resource 524 (e.g., NZP-CSI-RS-ResourceID) and an SSB-Index 526.

In some embodiments, beam failure recovery may be specified to enable a UE to recover from beam failure and continue communications on newly established beam pairs.

Various frameworks, such as those described herein, may be used for beam management between fixed JAB nodes, parent JAB nodes, and/or donor nodes and mobile nodes and/or child IAB nodes.

In certain embodiments, time-domain allocation parameters k0, k1, k2 (e.g., in NR) may be used herein and may defined.

PDSCH time-domain allocation: the RRC parameter k0 in RRC information element PDSCH-TimeDomainResourceAllocation may indicate an offset between a slot that contains a DCI that schedules a PDSCH transmission and a slot that contains the PDSCH transmission.

PDSCH hybrid automatic repeat request (“HARQ”) feedback timing: the L1 parameter k1 may be provided by the ‘PDSCH-to-HARQ_feedback timing indicator’ field in DCI formats 1_0 and 1_1 (e.g., for scheduling a PDSCH transmission).

Physical uplink shared channel (“PUSCH”) time-domain allocation: the RRC parameter k2 in the RRC information element PUSCH-TimeDomainResourceAllocation may indicate an offset between a slot that contains a DCI that schedules a PUSCH transmission and a slot that contains the PUSCH transmission.

In some embodiments, an IAB network may be connected to a core network through one or multiple IAB donors. Each IAB node may be connected to an IAB donor and/or other IAB nodes through wireless backhaul links. Each IAB donor and/or IAB node may also serve UEs.

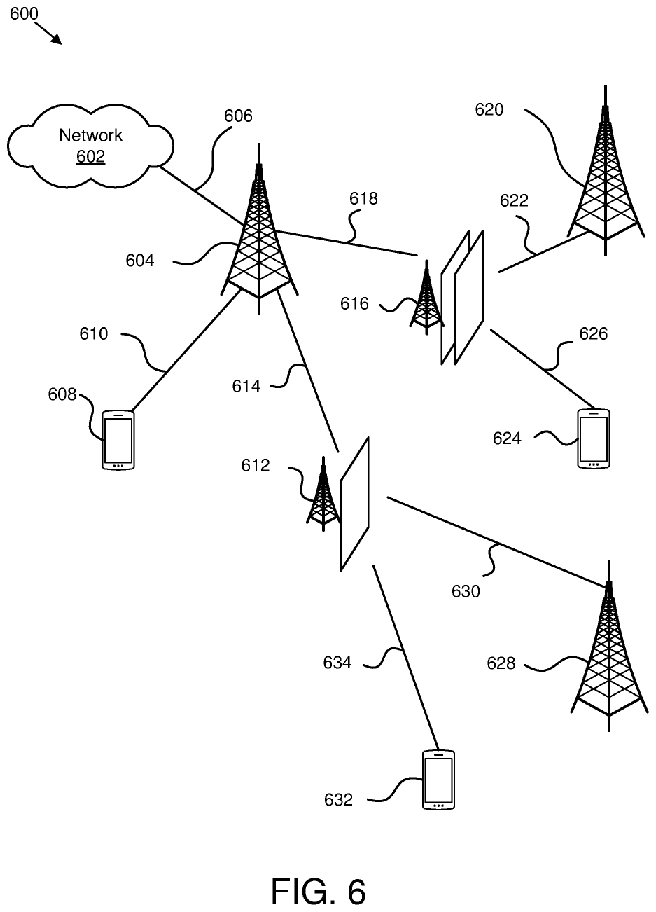

FIG. 6 is a diagram illustrating another embodiment of an IAB system 600. The IAB system 600 includes an IAB network 602 and an IAB donor 604 (e.g., parent IAB node) connected by a first backhaul link 606. The IAB system 600 includes a first UE 608 connected to the IAB donor 604 by a second backhaul link 610. Moreover, the IAB system 600 includes a first IAB node 612 (e.g., single-panel node) connected to the IAB donor 604 by a third backhaul link 614. Furthermore, the IAB system 600 includes a second IAB node 616 (e.g., multi-panel node) connected, through a first antenna panel of the IAB node 616, to the IAB donor 604 by a fourth backhaul link 618. The IAB system 600 includes a third IAB node 620 (e.g., child IAB node) connected to the second IAB node 616, through a second antenna panel of the IAB node 616, by a fifth backhaul link 622. Moreover, the IAB system 600 includes a second UE 624 connected to the second IAB node 616, through the first antenna panel or the second antenna panel of the IAB node 616, by a sixth backhaul link 626. Furthermore, the IAB system 600 includes a fourth IAB node 628 (e.g., child IAB node) connected to the first IAB node 612 by a seventh backhaul link 630. The IAB system 600 includes a third UE 632 connected to the first IAB node 612 by an eighth backhaul link 634.

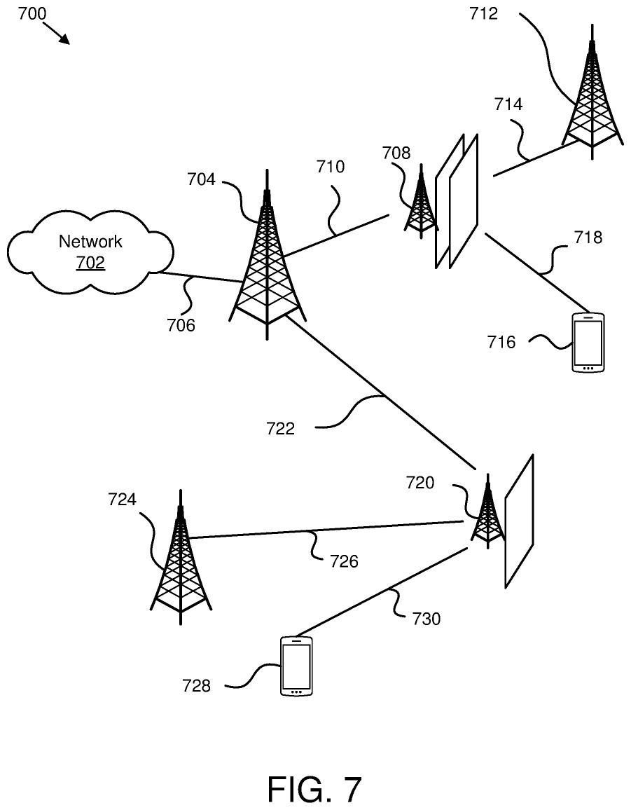

FIG. 7 is a diagram illustrating yet another embodiment of an IAB system 700 with single-panel and multi-panel IAB nodes. The IAB system 700 includes a network 702 and an IAB donor 704 (e.g., parent JAB node) connected by a first backhaul link 706. The JAB system 700 includes a first JAB node 708 (e.g., multi-panel node) connected, through a first antenna panel of the JAB node 708, to the IAB donor 704 by a second backhaul link 710. The JAB system 700 includes a second JAB node 712 (e.g., child JAB node) connected to the second JAB node 708, through a second antenna panel of the JAB node 708, by a third backhaul link 714. Moreover, the JAB system 700 includes a first UE 716 connected to the first JAB node 708, through the second antenna panel of the JAB node 708, by a fourth backhaul link 718. Furthermore, the JAB system 700 includes a third JAB node 720 (e.g., single-panel node) connected to the IAB donor 704 by a fifth backhaul link 722. Furthermore, the JAB system 700 includes a fourth JAB node 724 (e.g., child JAB node) connected to the third JAB node 720 by a sixth backhaul link 726. The JAB system 700 includes a second UE 728 connected to the third JAB node 720 by a seventh backhaul link 730.

In some embodiments, there may be various options with regards to a structure and multiplexing and/or duplexing capabilities of an JAB node. For example, each JAB node may have one or more antenna panels, array, and/or sub-arrays. Each of the one or more antenna panels, array, and/or sub-arrays may be connected to a baseband unit through one or more RF chains. One or more antenna panels may be able to serve a whole spatial area of interest in a vicinity of an JAB node, or each antenna panel or each group of antenna panels may provide a partial coverage (e.g., in a sector). An JAB node with multiple antenna panels, each serving a separate spatial area or sector, may be referred to as a single-panel JAB node as it behaves similarly to a single-panel JAB node for communications in each of the separate spatial areas or sectors.

In various embodiments, each antenna panel may be half-duplex (“HD”) (e.g., able to either transmit or receive signals in a frequency band at a time), or full-duplex (“FD”) (e.g., able to both transmit and receive signals in a frequency band simultaneously). Unlike full-duplex radio, half-duplex radio may be implemented and used in practice and may be assumed as a default mode of operation in a wireless systems.

Table 2 lists different duplexing scenarios that may be used if multiplexing is not constrained to time-division multiplexing (“TDM”). In Table 2, JAB node 1 (“N1”) is a single-panel JAB node; JAB node 2 (“N2”) is a multi-panel JAB node; spatial-division multiplexing (“SDM”) refers to either transmission or reception on downlink (or downstream) and uplink (or upstream) simultaneously; full duplex (“FD”) refers to simultaneous transmission and reception by the same antenna panel in a frequency band; and multi-panel transmission and reception (“MPTR”) refers to simultaneous transmission and reception by multiple antenna panels where each antenna panel either transmits or receives in a frequency band at a time.

TABLE 2

| Scenario | IAB-MT | IAB-DU | Type |
|---|---|---|---|
| S1 (Case B) | N1-DL-RX | N1-UL-RX | SDM |
| S2 (Case D) | N1-DL-RX | N1-DL-TX | FD |
| S3 (Case A) | N1-UL-TX | N1-DL-TX | SDM |
| S4 (Case C) | N1-UL-TX | N1-UL-RX | FD |
| S5 (Case B) | N2-DL-RX | N2-UL-RX | SDM |
| S6 (Case D) | N2-DL-RX | N2-DL-TX | MPTR/FD |
| S7 (Case A) | N2-UL-TX | N2-DL-TX | SDM |
| S8 (Case C) | N2-UL-TX | N2-UL-RX | MPTR/FD |

In one example, consider scenario S6 in which a multi-panel IAB node N2 receives a downlink control information (“DCI”) message (e.g., called DCI1) on a control channel scheduling a physical downlink shared channel (“PDSCH”) transmission (e.g., called PDSCH1), from a parent node to N2. Suppose N2 intends to schedule another downlink channel, called PDSCH2, from N2 to a child node or a user equipment. Since N2 has multiple panels, the two PDSCHs may be scheduled simultaneously, in addition to full duplex (“FD”), through a multi-panel transmission and/or reception (“MPTR”) and/or frequency-division multiplexing (“FDM”) scheme. However, since panel and/or beam selection in N1 for receiving PDSCH1 depends on the transmission configuration indication (“TCI”) in DCI1, N2 may receive DCI1 sufficiently in advance to produce and transmit a DCI message (e.g., called DCI2) which schedules PDSCH2. If this condition is not satisfied, PDSCH2 may not be scheduled in a timely manner, which may result in inefficient utilization of the hardware.

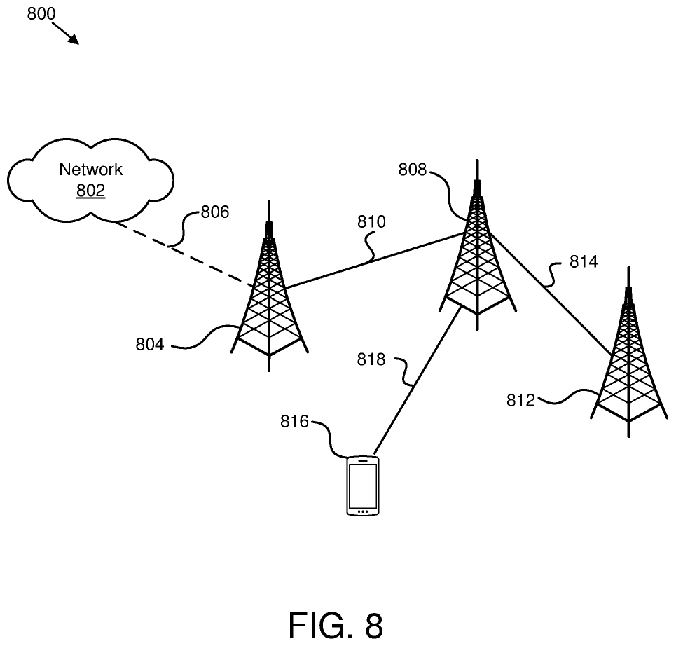

FIG. 8 is a diagram illustrating a further embodiment of an IAB system 800. The IAB system 800 includes a network 802 and a parent node 804 (e.g., PN) connected by a first backhaul link 806. The IAB system 800 includes an IAB node 808 (e.g., N) connected to the parent node 804 by a second backhaul link 810. The IAB system 800 includes a child IAB node 812 (e.g., CN) connected to the IAB node 808 by a third backhaul link 814. Moreover, the IAB system 800 includes a UE 816 connected to the JAB node 808 by a fourth backhaul link 818. Each of the parent node 804, the IAB node 808, and the child node 812 may be single-panel or multi-panel as described herein.

In various embodiments, an IAB system may determine whether resource are available (e.g., either configured hard, soft, or indicated available). In such embodiments, a granularity of availability of resources may be a symbol at all frequencies (e.g., within an active bandwidth part (“BWP”)). Even if a resource is not configured hard because it has periodic signals configured on it, a whole symbol may be considered hard.

In some embodiments, either all frequency resources on a symbol are available or none are available. This may be an issue in various embodiments in which enhanced duplexing allows FDM between communications (e.g., including communications in downstream and upstream).

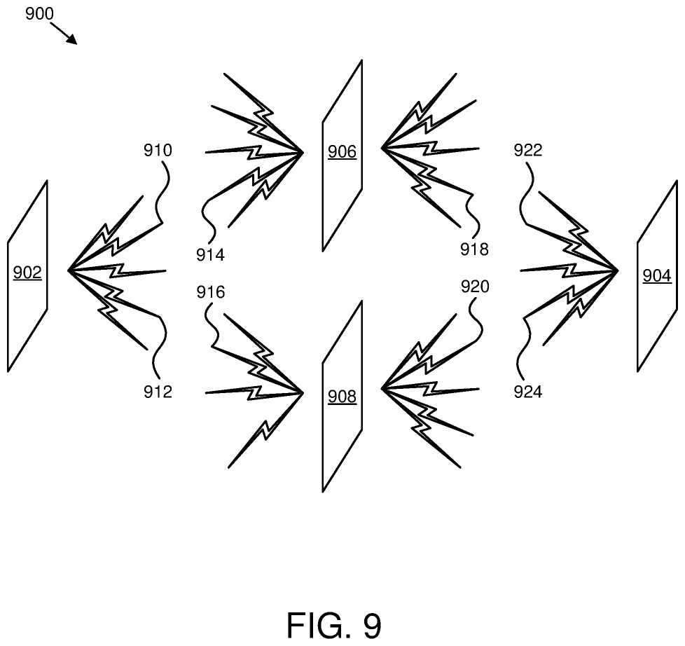

In certain embodiments, a system may employ beam management in which an operating frequency is in a millimeter-wave band (e.g., frequency range 2 (“FR2”)). A schematic of a wireless channel between PN, N, and CN and/or UE is illustrated in FIG. 9.

FIG. 9 is a schematic block diagram 900 illustrating one embodiment of a wireless channel between a multi-panel node, its parent node, and its child node. Specifically, the schematic block diagram 900 includes a first antenna panel for a parent node 902 (PN), a second antenna panel for a child node 904 (CN) (or UE), and an IAB node (N) having a first panel 906 (P1) and a second panel 908 (P2).

In FIG. 9, PN and CN and/or UE are shown as single-panel nodes. The IAB node N has two antenna panels P1 and P2. Each antenna panel on PN, N, and CN and/or UE may be able to transmit or receive signals through a number of beams. Beams of interest for describing certain embodiments include a first beam 910 B1, a second beam 912 B2, a third beam 914 B3, a fourth beam 916 B4, a fifth beam 918 B5, a sixth beam 920 B6, a seventh beam 922 B7, and an eight beam 924 B8. Each panel may be expected to be capable of applying one beam at a given time.

In various embodiments, to perform beam management, PN transmits reference signals, such as channel state information reference signals (“CSI-RS”) on one or more CSI-RS resources while applying different beams on different resources. N responds by transmitting a channel state information (“CSI”) report including at least one beam index (e.g., a CSI-RS resource index (“CRI”) corresponding to B1), and at least one corresponding value of channel quality (e.g., a reference signal receive power (“RSRP”)). Since N has multiple panels, it may report a second CRI corresponding to B2 and a corresponding RSRP. A beam management process may be performed as follows: 1) PN is informed that it may communicate with N through either B1 or B2; 2) N knows that a signal transmitted by PN through B1 may be received through B3 on P1, and a signal transmitted by PN through B2 may be received through B4 on P2; and 3) suppose that PN has data to transmit to N—then PN transmits a DCI to N that schedules a PDSCH transmission—the DCI may contain a TCI that indicates a QCL Type D (e.g., a spatial QCL) to B1 or B2—if a QCL Type D is indicated to B1, N may apply B3 on P1 to receive PDSCH signals on time and frequency resources specified by the DCI—otherwise, if a QCL Type D is indicated to B2, N may apply B4 on P2 to receive the PDSCH signals. By following a beam acquisition process, a TCI indication may be interpreted by a receiver as a beam and/or panel selection.

In some embodiments, a process may be applied to uplink communications (e.g., for N transmitting signals to PN in a PUSCH transmission). For uplink beam acquisition, PN and N may: 1) use downlink beams (e.g., transmit beams by PN and receive beams by N) in an opposite direction (e.g., receive beams by PN and transmit beams by N); and 2) perform a separate beam acquisition process including transmission of sounding reference signals (“SRS”) by N and measurements by PN—later, PN may indicate an SRS resource index (“SRI”) in DCI that schedules the PUSCH transmission.

As may be appreciated, beam management processes and communications between N and CN and/or UE may be similar to those between PN and N. Moreover, downlink communications from N to CN and/or UE may follow a beam acquisition process including CSI-RS transmissions by N and {CRI, RSRP} reporting by CN and/or UE. Furthermore, uplink communications transmitted from CN and/or UE to N may follow a separate beam acquisition process including SRS transmissions by CN and/or UE and measurements by N. In certain embodiments, if N schedules a communication with CN and/or UE, a QCL Type D indication to B5 or B6 may inform CN and/or UE that it should apply B7 or B8 for that communication, respectively.

In various embodiments, for scheduling simultaneous communications between PN-N and N-CN and/or UE links, N may be informed in advance of which of panels are selected for an upstream communication so that a different panel may be selected for a downstream communication.

In certain embodiments, panel and/or beam indication in FR2 may be used to inform about panel selection. In such embodiments, a first option may be to leave the matter to implementation, a second option may include defining rules that makes PN transmit a scheduling DCI sufficiently in advance, or a third option may include defining signaling that enables beam indication sufficiently in advance.

The first option may leave the matter of informing about panel selection to implementation without standard specifications. For example, PN may always transmit DCI sufficiently in advance to inform N in a timely manner and leave it sufficient time to schedule other communications with a CN and/or UE. As another example, in a saturated traffic configuration, N may predict what panel is going to be used in upcoming transmissions. As a further example, in a light traffic scenario, N may proceed with scheduling a communication of its own and, if panels and/or beams conflict, N may neglect one of the communications and handle errors through HARQ.

In the first option, the decision as to which scheduled communication is honored and which scheduled communication is neglected may depend on the following: 1) Quality-of-service (“QoS”): the decision as to which transport block is given higher priority is made based on a QoS criterion (e.g., as indicated by a QoS class indicator (“QCI”); and/or 2) HARQ redundancy version (“RC”): the decision as to which transport block is given higher priority is made based on a HARQ RV (e.g., a transport block with a higher HARQ RV may be given priority).

In the second option, rules may be defined in standard specifications that make a parent node schedule a communication and indicate QCL sufficiently in advance. For example, for downlink transmissions, since N needs sufficient time to receive and decode DCI from PN and to proceed to transmit DCI to a CN and/or UE, PN may set a higher layer parameter k0 to a value that is greater than or equal to a minimum threshold time.

The minimum threshold time for PN to transmit the scheduling DCI in advance may be a minimum time for N to receive and decode the DCI and produce its own scheduling DCI. This may be set to a constant by a standard, by configuration, or set to an JAB node capability. This capability may be similar to timeDurationForQCL. The parameter in Table 3 may be specified by standard or may be reported by an JAB node as a capability.

TABLE 3

| Parameter | Description |
|---|---|
| timeDurationForQCL2 | Defines the minimum time duration required by the IAB node to perform PDCCH |
| | reception and produce a DCI. If the parameter is expressed in units of OFDM symbols, |
| | the IAB node may indicate one value of minimum number of OFDM symbols for each |
| | value of subcarrier spacing. |

The parameter of Table 3 may be distinguished from timeDurationForQCL because it may include a time duration for an JAB node to produce DCI which includes processing rather than applying beams (e.g., spatial filters) that may take a shorter time to execute.

The threshold for parameter k0 may be set to a minimum time that N requires to decode the DCI plus a minimum time that N requires to transmit DCI of its own in advance. That is: k0_min(PN):=T_min(N)+k0_min(N). In this equation, k0_min(PN) is the minimum value of k0 for a PDSCH transmission from PN, T_min(N) is timeDurationForQCL2 for N, and k0_min(N) is the minimum value of k0 for a PDSCH from N.

Consider the following two examples: 1) a 2-hop system PN-N-UE: PN schedules a PDSCH transmission for N and N schedules a PDSCH transmission for UE—since N may schedule a PDSCH transmission for UE with k0=0, k0_min(N):=0 may be set—then, k0_min(PN) only depends on the minimum decoding time for N which may be set to a constant T_min(N):=T_min; and 2) the 3-hop system PN-N-CN-UE: {PN, N, CN} schedule PDSCH transmissions for {N, CN, UE}, respectively—then, the minimum value for k0 takes the following recursive form: k0_min(PN):=T_min(N)+k0_min(N), k0_min(N):=T_min(CN)+k0_min(CN). Since CN may schedule a PDSCH transmission for UE with k0=0, k0_min(CN):=0 may be set. Therefore: k0_min(N):=T_min(CN), k0 min(PN):=T_min(N)+T_min(CN). Assuming that T_min(N):=T_min(CN):=T_min, the following are obtained: k0_min(CN):=0, k0_min(N):=T_min, k0_min(PN):=2×T_min.

As may be appreciated, a recursive rule may be extended to a larger number of hops. For example, in an m-hop JAB system Nm- . . . -N1-N0-UE, assuming that all values of minimum DCI decoding time are identical, we have: k0_min(N0):=0, k0_min(N1):=T_min, . . . , k0_min(Nm):=m×T_min.

In certain embodiments, analog beamforming may not be used (e.g., if the carrier frequency is in frequency range 1 (“FR1”)). If analog beamforming is not used, k0 min(N0) may be set to 0. However, if analog beamforming is used (e.g., for frequency range 2 (FR2)), a UE may use an additional T_min(UE) to decode DCI and apply proper beams (e.g., QCL Type D) as indicated in TCI. If T_min(UE)=T_min, one may conclude that all k0_min values will increase by a value of T_min (e.g., k0_min(NO):=T_min, k0_min(N1):=2×T_min, . . . , k0_min(Nm):=(m+1)×T_min).

As may be appreciated, a similar method may be applied to uplink communications or a combination of downlink and uplink communications where values of k2 may be used. The above calculations may be extended to S5, S6, S7, and S8.

S5: PN transmits a PDSCH transmission to N; N receives a PUSCH transmission from CN: k0_min(PN):=T_min(N)+k2 min(N), k2 min(N):=T_min(CN)+k0_min(CN).

S6: PN transmits a PDSCH transmission to N; N transmits a PDSCH transmission to CN: k0_min(PN):=T_min(N)+k0 min(N), k0 min(N):=T_min(CN)+k0_min(CN).

S7: PN receives a PUSCH transmission from N; N transmits a PDSCH transmission to CN: k2_min(PN):=T_min(N)+k0 min(N), k0 min(N):=T_min(CN)+k2_min(CN).

S8: PN receives a PUSCH transmission from N; N receives a PUSCH transmission from CN: k2 min(PN):=T_min(N)+k2 min(N), k2 min(N):=T_min(CN)+k2_min(CN).

In the third option, there may be new signaling for beam indication. As may be appreciated, an issue with the second option is that PN may not have all scheduling information for k0 slots in advance. Instead, PN may be able to determine only a QCL indication in advance while leaving other scheduling information to a later time. Therefore, in the third option there may be new signaling that enables N to have beam indication information sufficiently in advance.

In a first embodiment of the third option, there may be anew DCI format that carries partial scheduling information (e.g., including a TCI or spatial relation information) instead of complete scheduling information. For example, a new DCI format 12 may be used that includes a subset of fields of DCI format 1_1 including the ‘transmission configuration indication’ (“TCI”) field. The new DCI format or the existence of certain fields in the new DCI format may be determined by a higher layer parameter. In certain embodiments, because this DCI (e.g., early DCI) may be used for other purposes, a higher layer parameter tci-PresentInDCI may also apply to this new DCI format.

Table 4 shows one embodiment of a method for an JAB node N for the first embodiment of the third option.

TABLE 4
Method for IAB node N

Receive a DCI (from PN) including:
A resource set R1
A TCI state T1 associated with R1
Obtain information about beam and/or panel B1 from T1 for an upstream communication C1 on R1
Select a TCI state T2 with an associated beam and/or panel B2 that is compatible with B1 for a
downstream communication C2 on a resource set R2
“Compatible” may mean that N may apply B1 for C1 and B2 for C2 simultaneously if R1 and
R2 overlap in time
Transmit DCI (to CN and/or UE) including:
The resource set R2
The TCI state T2 associated with R2
Receive a DCI (from PN) including scheduling information for a channel H1 on R1
Transmit a DCI (to CN and/or UE) including scheduling information for a channel H2 on R2
Perform communications on H1 while applying B1 and H2 while applying B2
Simultaneous operations if H1 and H2 overlap in time

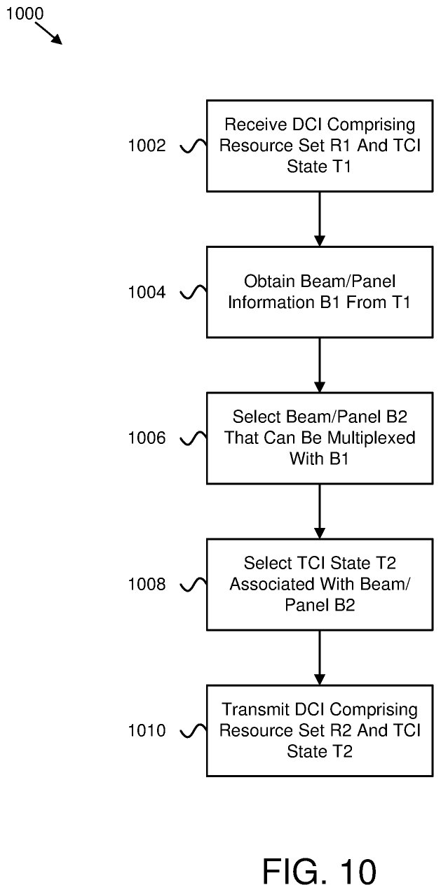

FIG. 10 is a flowchart diagram 1000 illustrating one embodiment of an early dynamic TCI state indication. The method for an IAB node N of the flowchart diagram 1000 includes an IAB node N receiving 1002 DCI including a TCI state indication T1 for upstream communications on a resource set R1; N obtaining 1004 beam and/or panel information B1 associated with the TCI state T1.

The method for the IAB node N further includes N considering 1006 the possibilities of multiplexing communications through a beam and/or panel B2 with beam and/or panel B1 (e.g., selecting the beam and/or panel B2 that can be multiplexed with B1). For FDM and/or SDM, the following constraints may apply: 1) MPTR: FDM is possible if the antenna panels for B1 and B2 are different; 2) SDM and/or HD: FDM is possible if the antenna panels for B1 and B2 are the same, beams for B1 and B2 are the same, and the communications are both transmissions or both receptions; 3) SDM and/or FD: FDM is possible if the antenna panels for B1 and B2 are the same and beams for B1 and B2 are the same; and/or 4) FDM is possible if B1 and B2 are the same or substantially overlapping (e.g., using the same or different antenna panels, for the same antenna panel power differences between the upstream and downstream transmission and maximum power reduction (“MPR”) and/or A-MPR due to inter-modulation due to simultaneous transmission may need to be taken in to account).

The method for the IAB node N further includes N selecting 1008 TCI state T2 associated with beam and/or panel B2. Furthermore, N transmits 1010 DCI indicating TCI state T2 for downstream communications on resource set R2 FDM'ed with R1. The DCI may be: 1) a conventional format (e.g., DCI format 11) if scheduling for a child IAB node or a UE; or 2) a new format for a child IAB node.

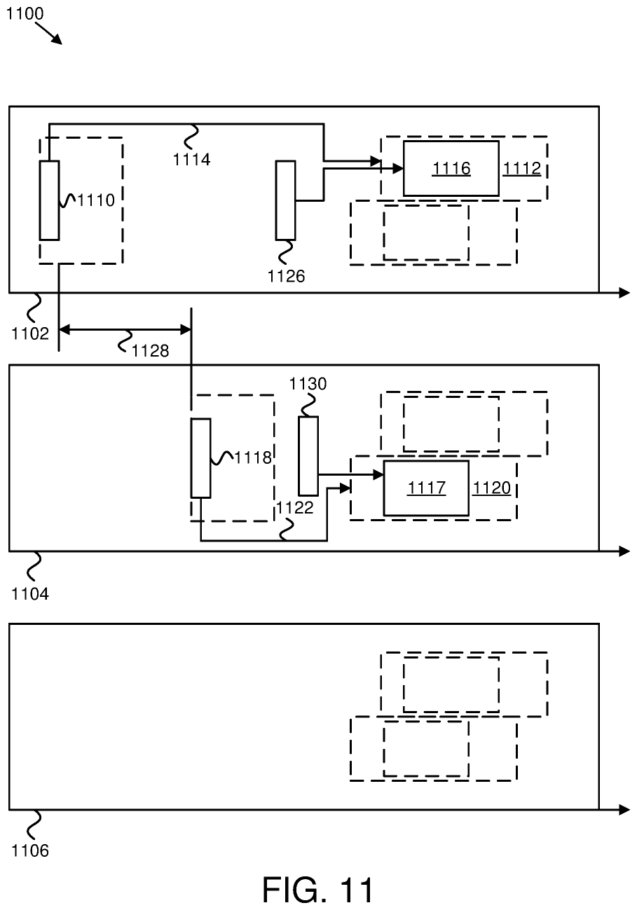

FIG. 11 is a timing diagram illustrating one embodiment of a timeline 1100 for early dynamic TCI state indication for a resource set. The timeline 1100 includes a PN time 1102, an N time 1104, and a CN time 1106.

In FIG. 11, a PN transmits a DC 1110 to an IAB node N. The DC 1110 contains information on a resource set R1 1112 and a TCI indication 1114 T1 (e.g., TCI state for R1). The difference between the DCI 1110 and DCI format 1_1 is that the DCI 1110 does not contain all the scheduling information for an upstream communication with N. Instead, the DCI 1110 conveys essential information for indicating an antenna panel and/or beam for potential communications on a channel 1116 H1 that may or may not use all the resources in the resource set 1112 R1.

Having received the DCI 1110 from PN, N may proceed with scheduling a channel 1117 H2 for a downstream communication with a CN or a UE. The scheduling may or may not be preceded by a DCI 1118 that determines a resource set 1120 R2 and a TCI state 1122 T2. The choice of TCI state 1122 T2 for communication on 1117 H2 may satisfy spatial constraints between resources in 1120 R2 and/or 1117 H2 and resources in 1112 R1.

Meanwhile, PN may also schedule the communication channel 1114 H1 to communicate with N via a DCI 1126.

Furthermore, a standard specification may determine a minimum time 1128 that an IAB node is required to transmit the DCI in advance. This threshold may be computed recursively based on a number of hops and a minimum time required by each node to decode a DCI. The threshold may be computed by higher layers based on node capabilities. The N may schedule the communication channel 1117 H2 via a DCI 1130.

The two-stage scheduling method of FIG. 11 may be similar to a two-stage sidelink control information (“SCI”) format used for NR sidelink. For example, a new DCI format may be transmitted on a physical downlink control channel (“PDCCH”) as a first stage, but a second DCI may be transmitted on a PDSCH as a second stage. In such embodiments, the second-stage DCI may not need blind decoding in a search space, but instead, the receiver may need to decode the second-stage DCI contained in the PDSCH payload according to information obtained from the first-stage DCI.

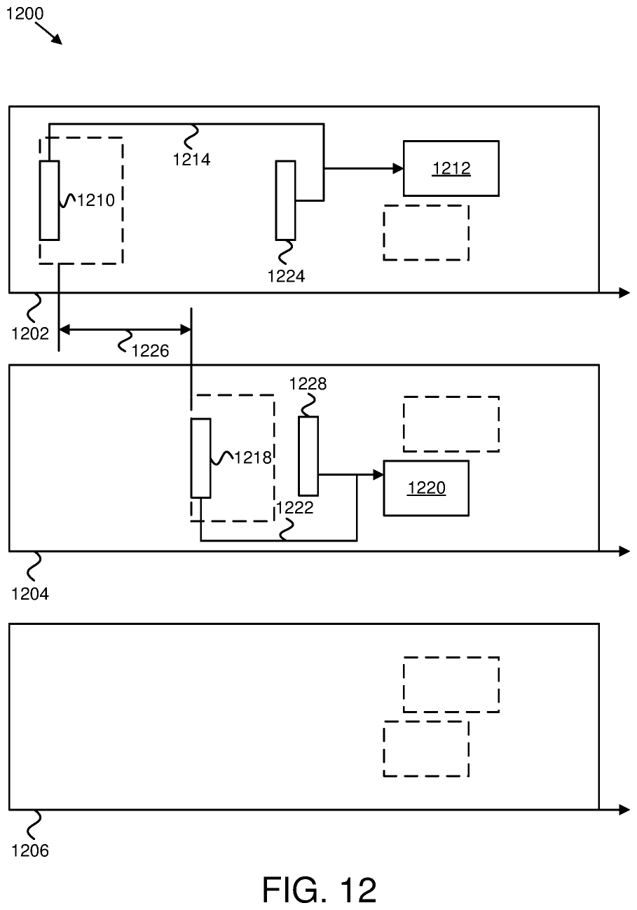

In FIG. 11, a DCI indicates a TCI state for a resource set from which a subset is selected by a later DCI for scheduling a channel. In certain embodiments, a DCI may indicate a TCI state for all resources on which a channel is scheduled by a later DCI, as shown in FIG. 12.

FIG. 12 is a timing diagram illustrating one embodiment of a timeline 1200 for early dynamic TCI state indication for a channel. The timeline 1200 includes a PN time 1202, an N time 1204, and a CN time 1206.

In FIG. 12, a PN transmits a DCI 1210 to an IAB node N. The DCI 1210 contains information on a resource set H1 1212 and a TCI indication 1214 T1 (e.g., TCI state for H1). Having received the DCI 1210 from PN, N may proceed with scheduling a channel 1216 H2 for a downstream communication with a CN or a UE. The scheduling may or may not be preceded by a DCI 1218 that determines a resource set 1220 H2 and a TCI state 1222 T2. Meanwhile, PN may also schedule the communication channel 1212 H1 to communicate with N via a DCI 1224. Furthermore, a standard specification may determine a minimum time 1226 that an IAB node is required to transmit the DCI in advance. This threshold may be computed recursively based on a number of hops and a minimum time required by each node to decode a DCI. The threshold may be computed by higher layers based on node capabilities. The N may schedule the communication channel 1220 H2 via a DCI 1228.

In FIG. 11 and FIG. 12, the DCI indicating a TCI state may use a new DCI format while the DCI scheduling a channel may have a new format or an existing format. In some embodiments, if the DCI scheduling a channel indicates a TCI state (e.g., a DCI format 1_1 is used while the higher layer parameter tci-PresentInDCI is enabled), the receiver may neglect a certain parameter.

In certain embodiments, each of an upstream channel H1 and a downstream channel H2 may be a downlink channel such as a PDSCH transmission or an uplink channel such as a PUSCH transmission. In such embodiments, there may be the following possible cases: 1) H1 is downlink, H2 is uplink, N is single-panel; 2) H1 is downlink, H2 is uplink, Ni is multi-panel; 3) H1 is downlink, H2 is downlink, N is single-panel; 4) H1 is downlink, H2 is downlink, N is multi-panel; 5) H1 is uplink, H2 is downlink, N is single-panel; 6) H1 is uplink, H2 is downlink, Ni is multi-panel; 7) H1 is uplink, H2 is uplink, N is single-panel; and 8) H1 is uplink, H2 is uplink, N is multi-panel.

For H1 is downlink, H2 is uplink, N is single-panel (e.g., scenario S1): N may need to receive downlink signals from PN and uplink signals from CN when applying one set of spatial parameters (e.g., one beam) on a single panel. Therefore, N may only indicate a TCI state in its first DCI to CN that needs application of spatial receive parameters that are similar to the spatial receive parameters that need to be applied according to the TCI state indicated by the first DCI from PN. Furthermore, N may execute appropriate power control and timing alignment processes for the simultaneous reception of signals.

For H1 is downlink, H2 is uplink, N is multi-panel (e.g., scenario S5): N may receive downlink signals from PN and uplink signals from CN by different panels or sets of panels. Therefore, once N determines the panel or set of panels that are indicated by the TCI state in its first DCI from PN, N may indicate a separate panel or set of panels and put an associated TCI state in its first DCI to CN.

For H1 is downlink, H2 is downlink, N is single-panel (e.g., scenario S2): the single-panel on N may be capable of full-duplex operation.

For H1 is downlink, H2 is downlink, N is multi-panel (e.g., scenario S6): N may receive downlink signals from PN and transmit downlink signals to CN by different panels or sets of panels. Therefore, once N determines the panel or set of panels that are indicated by the TCI state in its first DCI from PN, N may indicate a separate panel or set of panels and put an associated TCI state in its first DCI to CN.

For H1 is uplink, H2 is downlink, N is single-panel (e.g., scenario S3): N may need to transmit uplink signals to PN and downlink signals to CN if applying one set of spatial parameters (e.g., one beam) on a single panel. Therefore, N may only indicate a TCI state in its first DCI to CN that needs application of spatial transmit parameters that are similar to the spatial transmit parameters that need to be applied according to the TCI state indicated by the first DCI from PN. Furthermore, N may execute appropriate power control and timing alignment processes for the simultaneous reception of signals.

For H1 is uplink, H2 is downlink, N is multi-panel (e.g., scenario S7): N may transmit uplink signals to PN and downlink signals to CN by different panels or sets of panels. Therefore, once N determines the panel or set of panels that are indicated by the TCI state in its first DCI from PN, N may need to indicate a separate panel or set of panels and put an associated TCI state in its first DCI to CN.

For H1 is uplink, H2 is uplink, N is single-panel (e.g., scenario S4): the single-panel on N may be capable of full-duplex operation.

For H1 is uplink, H2 is uplink, N is multi-panel (e.g., scenario S8): N may transmit uplink signals to PN and receive uplink signals from CN by different panels or sets of panels. Therefore, once N determines the panel or set of panels that are indicated by the TCI state in its first DCI from PN, N may indicate a separate panel or set of panels and put an associated TCI state in its first DCI to CN.

It should noted that a multi-panel node may also be capable of single-panel operation. For example, in scenarios S1 and S3, if a set of spatial parameters on a panel or set of panels allow a node to communicate in both H1 and H2, the node may still indicate a TCI state to a child node and may use any extra panels for other simultaneous operations.

In some embodiments, an IAB node N may not receive information on resource set R1 and may select a TCI state T2 with associated beam and/or panel B2 based on beam and/or panel B1 corresponding to TCI state TI. In certain embodiments, an IAB node N may receive multiple possible TCI states T1 and may select a TCI state T2 with associated beam and/or panel B2 based on (e.g., that is compatible with) beam and/or panels B1 corresponding to each of the TCI states TI.

In various embodiments, an JAB node N may indicate to a PN a set of preferred TCI states (e.g., RS associated with TCI states received with good RSRP while giving flexibility for JAB node N to select TCI state T2 for downstream communication simultaneously with upstream communication using one of the TCI states from the preferred set). The PN may select at least one TCI state T1 for communication with the JAB node N from the set of preferred TCI states. In one example, the preferred set of TCI states may be indicated in a CSI report or a MAC CE and may be with a signal quality (e.g., RSRP) of an associated RS to each TCI state or a subset of the TCI states in the preferred TCI state set. In another example, the PN may configure an RSRP threshold and/or a minimum set size for the preferred TCI state set. In an additional example, the TCI state T1 selected from the preferred TCI state set may not be sent in advance of a new DCI format and may be sent together with scheduling information. In some embodiments, some TCI states in a preferred TCI state set may be configured but not activated. The PN may activate some of the TCI states from the preferred TCI state set.

In a second embodiment of the third option, if a higher layer parameter tci-PresentInDCI is enabled in a control resource set (“CORESET”) configuration, a TCI state may be indicated in DCI format 1_1 scheduling a PDSCH transmission. If present, the TCI state indication may be 3 bits, indicating one of at most 8 TCI states. Each TCI state may be configured by higher layers and activated by a MAC control element (“CE”) message. If there are more than 8 TCI states configured, a MAC CE message may be used to activate at most 8 of the TCI states at a time so that each of the activated TCI states may be indexed by 3 bits. In one embodiment, a TCI state or spatial relation (e.g., using SRI) may be used for the uplink and indicated in an uplink DCI format (e.g., DCI format 0_1) for scheduling PUSCH transmission.

In certain embodiments, an activation feature may be used to enable enhanced duplexing. If there are multiple TCI states configured, they may be used based on CSI processes. Each TCI state may be associated (e.g., at an JAB node) with an operation with an antenna and/or panel (e.g., from a set of antennas and/or panels) and a beam (e.g., from a set of beams on the antenna and/or panel). In some embodiments, activated TCI states may be associated with different antennas and/or panels. In such embodiments, an JAB node does not know about what antenna and/or panel may be selected for an upstream communication with a parent node. That may not allow the JAB node to schedule a downstream communication with a child node or a UE.

In various embodiments, if all activated TCI states are associated with one antenna and/or panel, an JAB node may know that other antennas and/or panels are not going to be used for an upstream communication which enables the IAB node to use them for downstream communications. It should be noted that a TCI state activation may be semi-persistent (e.g., the TCI state remains valid until another MAC CE message is received by the IAB node that modifies the set of activated TCI states or until the TCI states are expired by a timer or a change in connection).

In some embodiments, it may be unknown how to make sure that activated TCI states are associated with a subset of antennas and/or panels that enable another subset of antennas and/or panels for downstream communications, and a timing of activation and/or deactivation may be unknown.

In certain embodiments, there may be a groupBasedBeamReporting feature as shown in Table 5.

TABLE 5
If the UE is configured with a CSI-ReportConfig with the higher layer parameter reportQuantity set to ‘cri-RSRP’
or ‘ssb-Index-RSRP’,
if the UE is configured with the higher layer parameter groupBasedBeamReporting set to ‘disabled’, the
UE is not required to update measurements for more than 64 CSI-RS and/or SSB resources, and the UE
shall report in a single report nrofReportedRS (higher layer configured) different CRI or SSBRI for each
report setting.
if the UE is configured with the higher layer parameter groupBasedBeamReporting set to ‘enabled’, the UE
is not required to update measurements for more than 64 CSI-RS and/or SSB resources, and the UE shall
report in a single reporting instance two different CRI or SSBRI for each report setting, where CSI-RS
and/or SSB resources can be received simultaneously by the UE either with a single spatial domain
receive filter, or with multiple simultaneous spatial domain receive filters.
For L1-RSRP reporting, if the higher layer parameter nrofReportedRS in CSI-ReportConfig is configured to
be one, the reported L1-RSRP value is defined by a 7-bit value in the range [−140, −44] dBm with 1 dB step
size, if the higher layer parameter nrofReportedRS is configured to be larger than one, or if the higher
layer parameter groupBasedBeamReporting is configured as ‘enabled’, the UE shall use differential L1-
RSRP based reporting, where the largest measured value of L1-RSRP is quantized to a 7-bit value in the
range [−140, −44] dBm with 1 dB step size, and the differential L1-RSRP is quantized to a 4-bit value. The
differential L1-RSRP value is computed with 2 dB step size with a reference to the largest measured L1-
RSRP value which is part of the same L1-RSRP reporting instance. The mapping between the reported
L1-RSRP value and the measured quantity.

In various embodiments, if groupBasedBeamReporting is configured and set to ‘enabled’, a UE may report indices of two different reference signals that may be received simultaneously, either through two and/or multiple antennas and/or panels or through a same beam on a single antenna and/or panel.

In some embodiments, an L1-RSRP associated with a weaker reference signal of two reference signals may be reported differentially with respect to the L1-RSRP associated with the stronger reference signal. In such embodiments, this may be helpful for implementing enhanced duplexing if an JAB node reports two reference signals, each of which is received through a separate antenna and/or panel. Table 6 illustrates one embodiment of a method for an IAB node N.

TABLE 6
Method for an IAB node N

Receive configuration of CSI resources
Receive configuration of CSI reporting, wherein the configuration comprises the higher layer parameter
groupBasedBeamReporting set to ‘enabled’
Receive CSI on the configured CSI resources through two antennas and/or panels and preform
measurements
Transmit CSI report containing two resource indices and associated L1-RSRPs, wherein each of the two
resource indices and its associated L1-RSRP is associated with measurements by a separate antenna
and/or panel
Receive configuration of TCI states T
Receive TCI state activation activating a subset T1 of the TCI states T
If all TCI states in the subset T1 are associated with an antenna/panel P1
Transmit a DCI (to CN and/or UE) for scheduling a downstream communication, wherein the
DCI includes resources H2 and a TCI state associated with antenna/panel P2
Receive a DCI (from PN) scheduling an upstream communication, wherein the DCI includes resources
H1 and a TCI state from the subset T1
Perform communications on H1 while using antenna and/or panel P1 and H2 while using antenna and/or
panel P2
Simultaneous operations if H1 and H2 overlap in time

The method of Table 6 may have two drawbacks. A first drawback of the method of Table 6 may be that a number of activated TCI states is limited. Indeed, if a parent JAB node receives multiple pairs of two resource and/or beam indices in reports configured with groupBasedBeamReporting set to ‘enabled’, a relationship between resource indices of each pair may be specified by a standard, but such a relationship may not be specified across the reports. Therefore, TCI states associated with only one report may be activated if PN is to guarantee that a multi-panel N may be able to identify unused antennas and/or panels. That may limit the flexibility and performance of a system for scheduling and beam management. A second drawback of the method of Table 6 may be that the JAB node may report beams received through multiple antennas and/or panels or through one beam on a single antenna and/or panel. Hence, the effectiveness of the method of Table 6 may depend on N's voluntary cooperation without knowing in advance whether PN intends to use this for duplexing enhancement purposes. An explicit indication to N may be helpful.

In certain embodiments, it may be noted that RRC configurations come from an IAB donor CU, which may not be able to realize the JAB nodes' intention to perform FDM and/or SDM and configure CSI resources, CSI reporting, and TCI states accordingly. An explicit indication to the CU may be helpful.

In various embodiments, a group-based beam reporting method may be extended to enable reporting two or multiple subsets of beams if each subset is associated with a separate antenna and/or panel.

In some embodiments, a message from an JAB node N to a parent node PN may indicate a subset of TCI states associated with an antenna and/or panel or a group of antennas and/or panels from multiple antennas and/or panels. For example, a MAC CE message may include a bitmap or something similar to indicate to the PN the subset of the TCI states that are associated with an antenna and/or panel or a group of antennas and/or panels. If the PN activates TCI states associated with a subset of the multiple antennas and/or panels, N may infer that any other antennas and/or panels are not activated for upstream communications and may be used for scheduling downstream communications.

In certain embodiments, one message may contain information of association of one or more subsets of TCI states with one or more antennas and/or panels.

It should be noted that in a multi-hop JAB system, there may be a multi-hop delay in dynamic indications, activations, and/or semi-static indications of TCI states (e.g., referred to as TCI state indication) that may be related to a parameter similar to timeDurationForQCL3. One embodiment of timeDurationForQCL3 is shown in Table 7.

TABLE 7

| Parameter | Description |
|---|---|
| timeDurationForQCL3 | Defines the minimum time duration required by the IAB node to perform receive a first |
| | TCI state indication, produce a second TCI state indication, and transmit the second |
| | TCI state indication. If the parameter is a capability parameter expressed in units of |
| | OFDM symbols, the IAB node may indicate one value of minimum number of OFDM |
| | symbols for each value of subcarrier spacing. |

In various embodiments, if a TCI state indication is transmitted to a downstream node for a period T_{adv} prior to the start of an associated communication, a maximum number of hops that the information may travel is approximately equal to:

$${N}_{hops} = ⌈ \frac{{T}_{a d ν} - {D}_{1}}{{D}_{3}} ⌉ + 1 .$$

In this equation, D₁ and D₃ are timeDurationForQCL and timeDurationForQCL3, respectively.

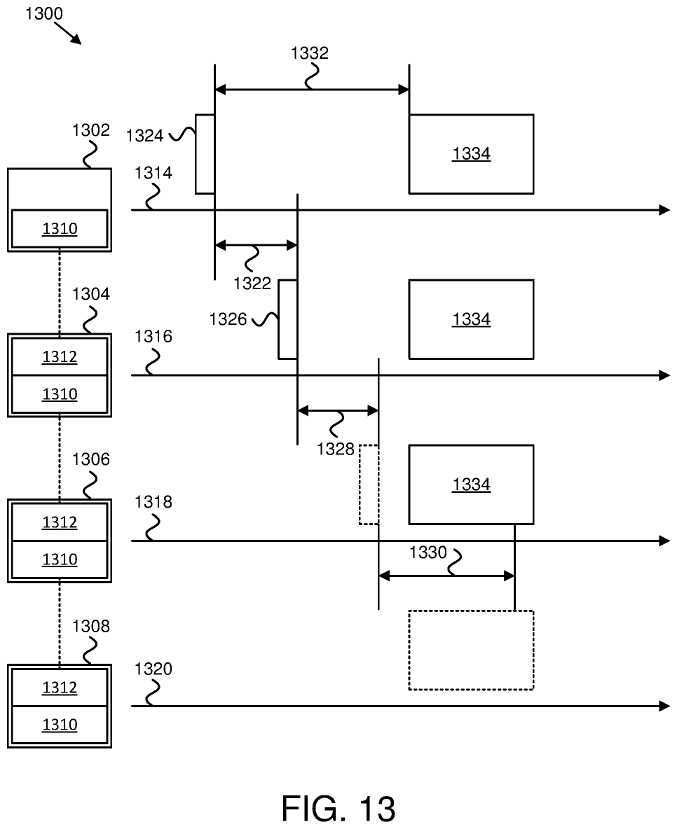

FIG. 13 is a timing diagram 1300 illustrating one embodiment of multi-hop delay for TCI state indications. The timing diagram 1300 illustrates node 1302 N1, node 1304 N2, node 1306, N3, and node 1308 N4. The nodes may include one or more of IAB-DU 1310 and IAB-MT 1312. Further, the timing diagram 1300 illustrates a time 1314 for N1, a time 1316 for N2, a time 1318 for N3, and a time 1320 for N4.

In FIG. 13, (N1, N2, N3) are parent nodes of (N2, N3, N4), respectively. N2 requires a minimum time 1322 D₃ to receive a TCI state indication T1 from message 1324 and produce and transmit a TCI state indication T2 from message 1326. Similarly, N3 requires a minimum 1328 D₃ to receive T2 from message 1326 and produce and transmit a TCI state indication T3. However, N3 may realize that N4 will not be left sufficient time 1330 (D₁) for decoding the TCI state indication and applying a beam or transmitting a TCI state indication of its own (D₃). Therefore, it refrains from transmitting T3. As a result, the sequence of TCI state indications that started with T1 for a period 1332 Ta_{d}v prior to the start of TX and/or RX resources 1334 travels for two hops. Hence, the N3-N4 link may not benefit from the TCI state indication.

To address this issue, N1 should set T_{adv} to a value sufficiently long. A minimum value may be configured by the CU as it is the entity that may be informed of topology information and capability information.

In some embodiments, a CU or a PN DU may indicate to N through control signaling that a feature is to be used for SDM. This embodiment may be combined with other embodiments.

In various embodiments, a CU indicates to N that a reporting configuration with groupBasedBeamReporting set to ‘enabled’ is to enable SDM. The indication may be sent by a higher layer based on capability information communicated to the CU via signaling or provided to the CU offline (e.g., by preconfiguration).

In certain embodiments, an explicit indication and/or request (e.g., a capability signaling) may be defined for JAB nodes (e.g., PN, N) and be provided to a CU for nodes that are capable of and/or interested in SDM. If the capability is received by both PN and N, then the CU may consider the information for configurations.

In some embodiments, a CU may receive SDM capability information of JAB nodes via signaling or by an offline method. Then, in such embodiments the CU may use the information to set a parameter in reporting configurations that shows an JAB node may use separate panels for a group-based beam reporting associated with a reporting configuration.

As may be appreciated, H1 and H2 resources may need to be separate in a frequency domain.

In various embodiments, an JAB node N may need to schedule a downstream communication in advance to enable a child node CN to decode DCI and apply parameters. For example, a minimum time duration to indicate a QCL may be timeDurationForQCL. However, N may receive a MAC CE message from a PN activating another subset of TCI states that changes the subset of antennas and/or panels available for downstream communications.

In certain embodiments, N may transmit its own MAC CE message changing a subset of active TCI states for a downstream communication once it receives a MAC CE message from PN that changes the subset of active TCI states for an upstream communication.

In some embodiments, proper timing for applying TCI activation and/or deactivation signaling may be used. For example, a TCI activation and/or deactivation message may only be applicable for an enhanced duplexing JAB node after X slots, where X is an integer parameter configured by higher layers.

In various embodiments, beam indication may be made semi-static for some or all resources. Signaling for the beam indication may be controlled by a MAC layer.

In certain embodiments, a set of resources may be semi-statically configured with one or more TCI states to inform an JAB node N in advance about a set and/or range of possibilities for TCI indication in upcoming communications in a resource set. This information may enable N to use other frequency resources on the semi-statically configured symbols for downlink transmissions of its own to a CN or UE.

Table 8 illustrates one embodiment of a method for an JAB node N.

TABLE 8
Method for an IAB node N

Receive RRC, MAC, and/or DCI signalling (from PN) including:
A periodic and/or semi-persistent resource set R1
A TCI state T1 associated with R1
Obtain information about beam and/or panel B1 from T1 for all upstream communications C1 on R1
Select a TCI state T2 with an associated beam and/or panel B2 that is compatible with B1 for all
downstream communications C2 on a periodic and/or semi-persistent resource set R2
“Compatible” may mean N may apply B1 for C1 and B2 for C2 simultaneously if R1 and R2
overlap in time
Transmit RRC, MAC, and/or DCI signalling (to CN and/or UE) including:
The periodic and/or semi-persistent resource set R2
The TCI state T2 associated with R2
Receive DCI (from PN) including scheduling information for a channel H1 on R1
Transmit a DCI (to CN and/or UE) including scheduling information for a channel H2 on R2
Perform communications on H1 while applying B1 and H2 while applying B2
Simultaneous operations if H1 and H2 overlap in time

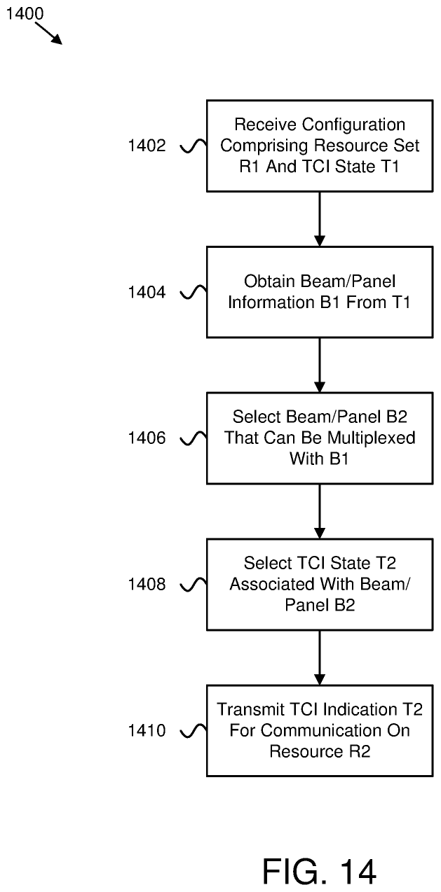

FIG. 14 is a flowchart diagram 1400 illustrating one embodiment of a semi-static TCI state configuration. The flowchart diagram 1400 illustrates one embodiment of a method for an IAB node N including the IAB node N receiving 1402 a configuration including a resource set R1 and an associated set of TCI states T1. Furthermore, MAC signaling may activate and/or deactivate TCI states from the set of TCI states, in which case T1 is the set of active TCI states. R1 and T1 may be associated with upstream communications with respect to N.

N obtains 1404 beam and/or panel information B1 associated with the TCI states T1.

Then, N considers 1406 the possibilities of multiplexing communications through a beam and/or panel B2 with beam and/or panel B1 (e.g., select beam and/or panel information B1 from T1). For FDM and/or SDM, the following constraints may apply: 1) MPTR: FDM is possible if the antenna panels for B1 and B2 are different; 2) SDM and/or HD: FDM is possible if the antenna panels for B1 and B2 are the same, beams for B1 and B2 are the same, and both communications are transmissions or receptions; 3) SDM and/or FD: FDM is possible if the antenna panels for B1 and B2 are the same and beams for B1 and B2 are the same.

Next, N selects 1408 TCI states T2 associated with beam and/or panel B2. Finally, N transmits 1410 an indication of TCI state T2 for communication on resource R2 FDM'ed with R1.

In certain embodiments, an JAB node may need to consider inter-panel interference in MPTR based on its own capability. Details of how the capability information is used may be left to implementation.

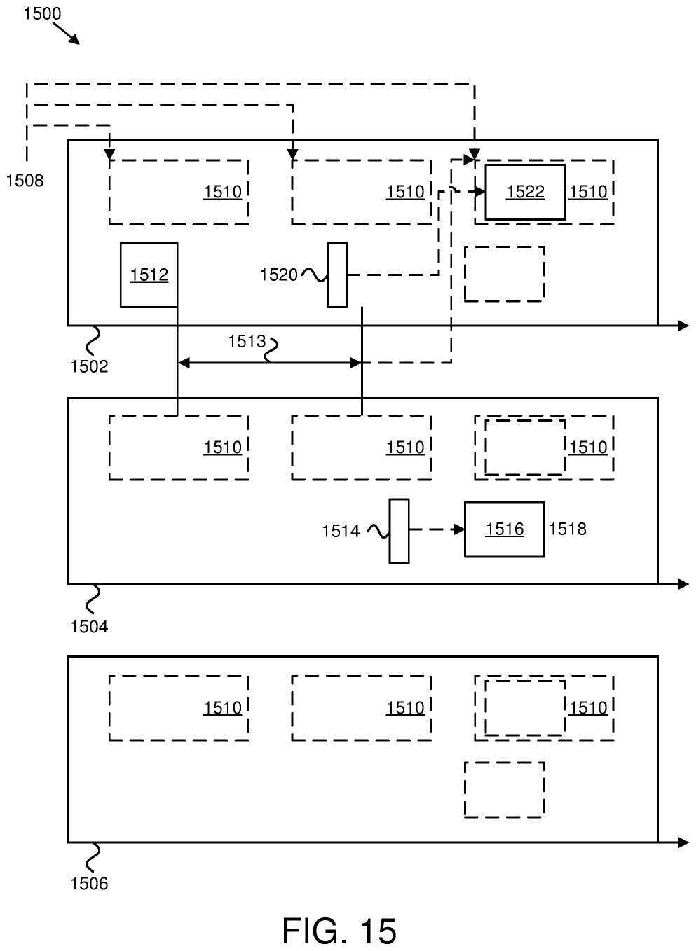

FIG. 15 is a timing diagram illustrating one embodiment of a timeline 1500 for semi-static TCI state configuration. The timeline 1500 includes a PN time 1502, an N time 1504, and a CN time 1506.

In FIG. 15, the JAB node N receives a semi-static configuration 1508 including a resource set 1510 R1. The semi-static configuration 1508 may further include a set of TCI states. If more than one TCI state (e.g., TO and T1) are configured for the resource set 1510, a MAC message 1512 may activate or deactivate TCI states from the set after a time period 1513. In this example, the MAC message 1512 activates TCI state T1 corresponding to an antenna panel, which allows N to know in advance which other antenna panel it has available for downstream communications.

Then, N may proceed to scheduling via a DCI 1514 a channel 1516 H2 on resources 1518 R2, FDM'ed with R1, for a downstream communication with a CN or a UE. The TCI state T2 indicated in the DCI 1514 is associated with an antenna panel not associated with T1.

Meanwhile, PN may also schedule via a DCI 1520 a communication channel 1522 H1 on R1 to communicate with N.

In FIG. 15, each of the upstream channel 1522 H1 and the downstream channel 1516 H2 may be a downlink channel such as a PDSCH or an uplink channel such as a PUSCH. In such embodiments, there may be the following possible cases: 1) H1 is downlink, H2 is uplink, N is single-panel; 2) H1 is downlink, H2 is uplink, Ni is multi-panel; 3) H1 is downlink, H2 is downlink, N is single-panel; 4) H1 is downlink, H2 is downlink, N is multi-panel; 5) H1 is uplink, H2 is downlink, N is single-panel; 6) H1 is uplink, H2 is downlink, Ni is multi-panel; 7) H1 is uplink, H2 is uplink, N is single-panel; and 8) H1 is uplink, H2 is uplink, N is multi-panel.

For H1 is downlink, H2 is uplink, N is single-panel (e.g., scenario S1): N may need to receive downlink signals from PN and uplink signals from CN if applying one set of spatial parameters (e.g., one beam) on a single panel. Therefore, N may only indicate a TCI state in the DCI to CN that needs application of spatial receive parameters that are similar to the spatial receive parameters that need to be applied according to the TCI state activated by the MAC CE message from PN. Furthermore, N may execute appropriate power control and timing alignment processes for the simultaneous reception of signals.

For H1 is downlink, H2 is uplink, N is multi-panel (e.g., scenario S5): N may receive downlink signals from PN and uplink signals from CN by different panels or sets of panels. Therefore, once N determines the panel or set of panels that are activated by the TCI state in the MAC CE message from PN, N may indicate a separate panel or set of panels and put an associated TCI state in the DCI to CN.

For H1 is downlink, H2 is downlink, N is single-panel (e.g., scenario S2): the single-panel on N may be capable of full-duplex operation.

For H1 is downlink, H2 is downlink, N is multi-panel (e.g., scenario S6): N may receive downlink signals from PN and transmit downlink signals to CN by different panels or sets of panels. Therefore, once N determines the panel or set of panels that are indicated by the TCI state in the MAC CE message from PN, N may indicate a separate panel or set of panels and put an associated TCI state in the DCI to CN.

For H1 is uplink, H2 is downlink, N is single-panel (e.g., scenario S3): N may need to transmit uplink signals to PN and downlink signals to CN if applying one set of spatial parameters (e.g., one beam) on a single panel. Therefore, N may only indicate a TCI state in the DCI to CN that needs application of spatial transmit parameters that are similar to the spatial transmit parameters that are applied according to the TCI state activated by the MAC CE message from PN. Furthermore, N may execute appropriate power control and timing alignment processes for the simultaneous reception of signals.

For H1 is uplink, H2 is downlink, N is multi-panel (e.g., scenario S7): N may transmit uplink signals to PN and downlink signals to CN by different panels or sets of panels. Therefore, once N determines the panel or set of panels that are activated by the TCI state in the MAC CE message from PN, N may indicate a separate panel or set of panels and put an associated TCI state in the DCI to CN.

For H1 is uplink, H2 is uplink, N is single-panel (e.g., scenario S4): the single-panel on N may be capable of full-duplex operation.

For H1 is uplink, H2 is uplink, N is multi-panel (e.g., scenario S8): N may transmit uplink signals to PN and receive uplink signals from CN by different panels or sets of panels. Therefore, once N determines the panel or set of panels that are indicated by the TCI state in the MAC CE message from PN, N may indicate a separate panel or set of panels and put an associated TCI state in the DCI to CN.

It should be noted that a multi-panel node may be capable of single-panel operation. For example, in scenarios S1 and S3, if a set of spatial parameters on a panel or set of panels enable a node to communicate in both H1 and H2, the node may still indicate a TCI state to a child node and may use any extra panels for other simultaneous operations.

Further, it should be noted that various embodiments may be extended to a system with a larger number of hops. For example, in a multi-hop system N1-N2-N3-N4, where (N1, N2, N3) are parent nodes of (N2, N3, N4), respectively, N1 may send a semi-static TCI state indication T1 to N2 and N2 may send a semi-static TCI state indication T2 to N3 according to the information obtained from T1. Then, N3 may send a TCI state indication T3 to N4 by DCI or by another semi-static signaling.

Certain embodiments herein may be described with emphasis on scenario S6 (e.g., downlink from PN to N and downlink from N to CN and/or UE). However, any embodiments (e.g., such as the multi-panel scenarios S5-S8) may use elements of other embodiments.

For S5: N may receive a PDSCH transmission from PN and receive a PUSCH transmission from CN and/or UE. Therefore: k0 min(PN):=T_min(N)+k2 min(N), k2_min(N) T_min(CN)+k0_min(CN).

For S6: N may receive a PDSCH transmission from PN and transmit a PDSCH transmission to CN and/or UE. Therefore: k0_min(PN)=T_min(N)+k0 min(N), k0 min(N) T_min(CN)+k0_min(CN).

For S7: N may transmit a PUSCH transmission to PN and transmit a PDSCH transmission to CN and/or UE. Therefore: k2_min(PN):=T_min(N)+k0 min(N), k0 min(N) T_min(CN)+k2_min(CN).

For S8: N may transmit a PUSCH transmission to PN and receive a PUSCH transmission from CN and/or UE. Therefore: k2 min(PN):=T_min(N)+k2 min(N), k2_min(N):=T_min(CN)+k2_min(CN).

Further embodiments may include the following:

For S5: N may receive an H1=PDSCH from PN and receive an H2=PUSCH from CN and/or UE. Therefore, R1 may be selected from resources configured as downlink and R2 may be selected from resources configured as uplink. The corresponding DCI formats, for example, may be format 1_0 and/or 1_1 and 0_0 and/or 0_1, respectively.

For S6: N may receive an H1=PDSCH from PN and transmit an H2=PDSCH to CN and/or UE. Therefore, R1 may be selected from resources configured as downlink and R2 may be selected from resources configured as downlink. The corresponding DCI formats, for example, may be format 1_0 and/or 1_1 and 1_0 and/or 1_1, respectively.

For S7: N may transmit an H1=PUSCH to PN and transmit an H2=PDSCH to CN and/or UE. Therefore, R1 may be selected from resources configured as uplink and R2 may be selected from resources configured as downlink. The corresponding DCI formats, for example, may be format 0_0 and/or 0_1 and 1_0 and/or 1_1, respectively.

For S8: N may transmit an H1=PUSCH to PN and receive an H2=PUSCH from CN and/or UE. Therefore, R1 may be selected from resources configured as uplink and R2 may be selected from resources configured as uplink. The corresponding DCI formats, for example, may be format 0_0 and/or 0_1 and 0_0 and/or 0_1, respectively.

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)0, or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices, such as a CU, the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/pr unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4)‘QCL-TypeD’: {Spatial Rx parameter}.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In various embodiments, a transmission configuration indicator (“TCI”) state associated with a target transmission may indicate a quasi-collocation relationship between a target transmission (e.g., target RS of demodulation reference signal (“DM-RS”) ports of the target transmission during a transmission occasion) and source reference signals (e.g., synchronization signal block (“SSB”), channel state information reference signal (“CSI-RS”), and/or sounding reference signal (“SRS”)) with respect to quasi co-location type parameters indicated in a corresponding TCI state. A device may receive a configuration of multiple transmission configuration indicator states for a serving cell for transmissions on the serving cell (e.g., between a parent IAB-DU and IAB-node MT).

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

As described herein, entities may be referred to as JAB nodes. As may be appreciated, an embodiments that refer to JAB nodes, may also refer to IAB donors (which are JAB entities connecting the core network to the JAB network).

The different steps described for different embodiments herein may be permuted.

Each configuration described herein may be provided by one or more configurations. In some embodiments, an earlier configuration described herein may provide a subset of parameters while a later configuration may provide another subset of parameters. In certain embodiments, a later configuration may override values provided by an earlier configuration or a pre-configuration.

In various embodiments, a configuration may be provided by radio resource control (“RRC”) signaling, medium-access control (“MAC”) signaling, physical layer signaling such as a downlink control information (“DCI”) message, and/or other means. Moreover, in such embodiments, a configuration may include a pre-configuration or a semi-static configuration provided by a standard, a vendor, a network, and/or an operator. Each parameter value received through a configuration or indication may override previous values for a similar parameter.

As may be appreciated, embodiments described herein may be applicable to any wireless system, wireless relay nodes, and/or other types of wireless communication entities.

In some embodiments, certain beams on one panel may cause significant interference on another panel and, therefore, certain combinations of beams may be avoided. Such issues may be avoided by using an early TCI indication transmitted to N2.

In various embodiments, embodiments described herein may change based on a paired spectrum. As used herein, “HARQ-ACK” may represent collectively a positive acknowledge (“ACK”) and a negative acknowledge (“NACK”). ACK may mean that a transport block (“TB”) is correctly received while NACK (or NAK) may mean that a TB is erroneously received.

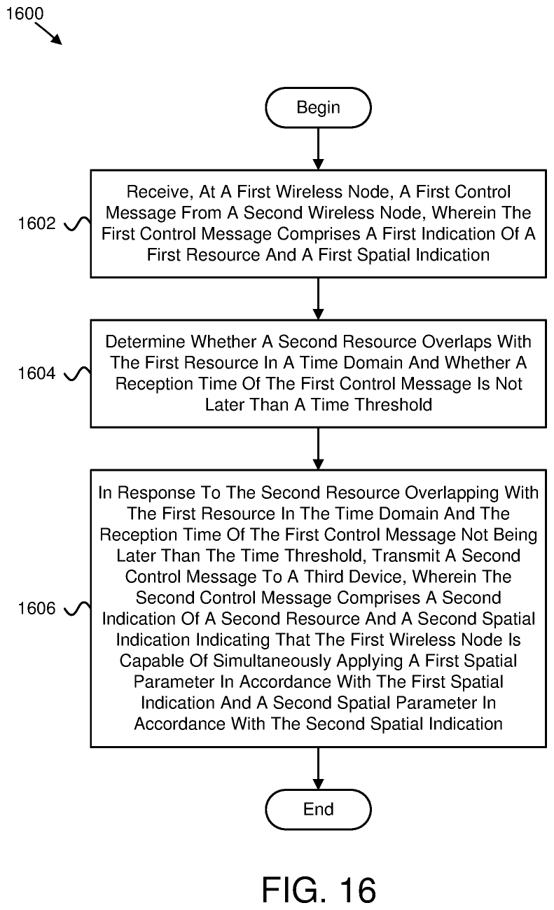

FIG. 16 is a flow chart diagram illustrating one embodiment of a method 1600 for spatial parameter capability indication. In some embodiments, the method 1600 is performed by an apparatus, such as the remote unit 102 and/or the network unit 104. In certain embodiments, the method 1600 may be performed by a processor executing program code, for example, a microcontroller, a microprocessor, a CPU, a GPU, an auxiliary processing unit, a FPGA, or the like.

In various embodiments, the method 1600 includes receiving 1602, at a first wireless node, a first control message from a second wireless node, wherein the first control message comprises a first indication of a first resource and a first spatial indication. In some embodiments, the method 1600 includes determining 1604 whether a second resource overlaps with the first resource in a time domain and whether a reception time of the first control message is not later than a time threshold. In various embodiments, the method 1600 includes, in response to the second resource overlapping with the first resource in the time domain and the reception time of the first control message not being later than the time threshold, transmitting 1606 a second control message to a third device, wherein the second control message comprises a second indication of a second resource and a second spatial indication indicating that the first wireless node is capable of simultaneously applying a first spatial parameter in accordance with the first spatial indication and a second spatial parameter in accordance with the second spatial indication.

In certain embodiments, the time threshold is determined based on a minimum duration for decoding the first control message, encoding the second control message, and transmitting the second control message by the first wireless node. In some embodiments, the time threshold equals a time of the first resource minus the minimum duration. In various embodiments, the time threshold equals a time of the second resource minus the minimum duration.

In one embodiment: the first spatial indication is a first transmission configuration indicator state, and the first resource is a downlink resource; or the first spatial indication is a first spatial relation information parameter and the first resource is an uplink resource. In certain embodiments: the second spatial indication is a second transmission configuration indicator state, and the second resource is a downlink resource; or the second spatial indication is a second spatial relation information parameter and the second resource is an uplink resource. In some embodiments, the capability is determined based on a number of antenna panels at the first wireless node.

In various embodiments, the capability is determined based on whether the first wireless node comprises a full-duplexing capability. In one embodiment, the capability is determined based on whether the first resource and the second resource overlap in a frequency domain. In certain embodiments, the capability is further determined based on whether the first spatial parameter is equal to the second spatial parameter.

In some embodiments, the second wireless node provides a first serving cell for the first wireless node, and the first wireless node provides a second serving cell for a third wireless node. In various embodiments, the method further comprises: performing a first operation on the first resource while applying the first spatial parameter, wherein the first operation comprises a first transmission to the second wireless node and a first reception from the second wireless node; and performing a second operation on the second resource while applying the second spatial parameter, wherein the second operation comprises a first transmission to the third wireless node and a second reception from the third wireless node.

In one embodiment, a method comprises: receiving, at a first wireless node, a first control message from a second wireless node, wherein the first control message comprises a first indication of a first resource and a first spatial indication; determining whether a second resource overlaps with the first resource in a time domain and whether a reception time of the first control message is not later than a time threshold; and in response to the second resource overlapping with the first resource in the time domain and the reception time of the first control message not being later than the time threshold, transmitting a second control message to a third device, wherein the second control message comprises a second indication of a second resource and a second spatial indication indicating that the first wireless node is capable of simultaneously applying a first spatial parameter in accordance with the first spatial indication and a second spatial parameter in accordance with the second spatial indication.

In certain embodiments, the time threshold is determined based on a minimum duration for decoding the first control message, encoding the second control message, and transmitting the second control message by the first wireless node.

In some embodiments, the time threshold equals a time of the first resource minus the minimum duration.

In various embodiments, the time threshold equals a time of the second resource minus the minimum duration.

In one embodiment: the first spatial indication is a first transmission configuration indicator state, and the first resource is a downlink resource; or the first spatial indication is a first spatial relation information parameter and the first resource is an uplink resource.

In certain embodiments: the second spatial indication is a second transmission configuration indicator state, and the second resource is a downlink resource; or the second spatial indication is a second spatial relation information parameter and the second resource is an uplink resource.

In some embodiments, the capability is determined based on a number of antenna panels at the first wireless node.

In various embodiments, the capability is determined based on whether the first wireless node comprises a full-duplexing capability.

In one embodiment, the capability is determined based on whether the first resource and the second resource overlap in a frequency domain.

In certain embodiments, the capability is further determined based on whether the first spatial parameter is equal to the second spatial parameter.

In some embodiments, the second wireless node provides a first serving cell for the first wireless node, and the first wireless node provides a second serving cell for a third wireless node.

In various embodiments, the method further comprises: performing a first operation on the first resource while applying the first spatial parameter, wherein the first operation comprises a first transmission to the second wireless node and a first reception from the second wireless node; and performing a second operation on the second resource while applying the second spatial parameter, wherein the second operation comprises a first transmission to the third wireless node and a second reception from the third wireless node.

In one embodiment, an apparatus comprises: a receiver that receives, at a first wireless node, a first control message from a second wireless node, wherein the first control message comprises a first indication of a first resource and a first spatial indication; a processor that determines whether a second resource overlaps with the first resource in a time domain and whether a reception time of the first control message is not later than a time threshold; and a transmitter that, in response to the second resource overlapping with the first resource in the time domain and the reception time of the first control message not being later than the time threshold, transmits a second control message to a third device, wherein the second control message comprises a second indication of a second resource and a second spatial indication indicating that the first wireless node is capable of simultaneously applying a first spatial parameter in accordance with the first spatial indication and a second spatial parameter in accordance with the second spatial indication.

In certain embodiments, the time threshold is determined based on a minimum duration for decoding the first control message, encoding the second control message, and transmitting the second control message by the first wireless node.

In some embodiments, the time threshold equals a time of the first resource minus the minimum duration.

In various embodiments, the time threshold equals a time of the second resource minus the minimum duration.

In one embodiment: the first spatial indication is a first transmission configuration indicator state, and the first resource is a downlink resource; or the first spatial indication is a first spatial relation information parameter and the first resource is an uplink resource.

In certain embodiments: the second spatial indication is a second transmission configuration indicator state, and the second resource is a downlink resource; or the second spatial indication is a second spatial relation information parameter and the second resource is an uplink resource.

In some embodiments, the capability is determined based on a number of antenna panels at the first wireless node.

In various embodiments, the capability is determined based on whether the first wireless node comprises a full-duplexing capability.

In one embodiment, the capability is determined based on whether the first resource and the second resource overlap in a frequency domain.

In certain embodiments, the capability is further determined based on whether the first spatial parameter is equal to the second spatial parameter.

In some embodiments, the second wireless node provides a first serving cell for the first wireless node, and the first wireless node provides a second serving cell for a third wireless node.

In various embodiments, the processor: performs a first operation on the first resource while applying the first spatial parameter, wherein the first operation comprises a first transmission to the second wireless node and a first reception from the second wireless node; and performs a second operation on the second resource while applying the second spatial parameter, wherein the second operation comprises a first transmission to the third wireless node and a second reception from the third wireless node.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-20. (canceled)

21. An apparatus for wireless communication, the apparatus comprising a first integrated access and backhaul (IAB) node, the apparatus further comprising:
a processor; and
a memory coupled to the processor, the processor configured to cause the apparatus to:
receive a control message from a second IAB node, wherein the control message comprises a spatial parameter associated with a set of resources; and
determine, for an IAB distributed unit (IAB-DU) of the IAB node, whether to perform a communication based on the spatial parameter and whether the communication is concurrent with the set of resources.

22. The apparatus of claim 21, wherein the second IAB node is a parent node of the first IAB node.

23. The apparatus of claim 21, wherein the spatial parameter is a quasi-co-location (QCL) indication.

24. The apparatus of claim 21, wherein the spatial parameter is a transmission configuration indication (TCI) state associated with an IAB mobile terminal (IAB-MT) of the IAB node.

25. The apparatus of claim 21, wherein the set of resources is configured by radio resource control (RRC) signaling.

26. The apparatus of claim 21, wherein the communication is a transmission, a reception, or a combination thereof.

27. The apparatus of claim 21, wherein the processor causing the apparatus to determine whether to perform the communication based on the spatial parameter and whether the communication is concurrent with the set of resources is further based on whether the communication is on a second frequency that is separate from a first frequency associated with the set of resources.

28. The apparatus of claim 21, wherein the processor causing the apparatus to determine whether to perform the communication based on the spatial parameter and whether the communication is concurrent with the set of resources is further based on whether the communication overlaps with the set of resources.

29. The apparatus of claim 21, wherein the control message comprises a medium access control (MAC) control element (CE).

30. A method at a first integrated access and backhaul (IAB) node, the method comprising:
receiving a control message from a second IAB node, wherein the control message comprises a spatial parameter associated with a set of resources; and
determining, for an IAB distributed unit (IAB-DU) of the IAB node, whether to perform a communication based on the spatial parameter and whether the communication is concurrent with the set of resources.

31. The method of claim 30, wherein the second IAB node is a parent node of the first IAB node.

32. The method of claim 30, wherein the spatial parameter is a quasi-co-location (QCL) indication.

33. The method of claim 30, wherein the spatial parameter is a transmission configuration indication (TCI) state associated with an IAB mobile terminal (IAB-MT) of the IAB node.

34. The method of claim 30, wherein the set of resources is configured by radio resource control (RRC) signaling.

35. The method of claim 30, wherein the communication is a transmission, a reception, or a combination thereof.

36. The method of claim 30, wherein determining whether to perform the communication based on the spatial parameter and whether the communication is concurrent with the set of resources is further based on whether the communication is on a second frequency that is separate from a first frequency associated with the set of resources.

37. The method of claim 30, wherein determining whether to perform the communication based on the spatial parameter and whether the communication is concurrent with the set of resources is further based on whether the communication overlaps with the set of resources.

38. The method of claim 30, wherein the control message comprises a medium access control (MAC) control element (CE).

39. An apparatus for wireless communication, the apparatus comprising a first integrated access and backhaul (IAB) node, the apparatus further comprising:
a processor; and
a memory coupled to the processor, the processor configured to cause the apparatus to:
receive a medium access control (MAC) control element (CE) from a parent node, wherein the MAC CE comprises a quasi-collocation (QCL) indication associated with a set of resources; and
determine, for an IAB distributed unit (IAB-DU) of the IAB node, whether to perform a transmission, a reception, or a combination thereof based at least in part on the QCL indication and whether the transmission, the reception, or the combination thereof is concurrent with the set of resources.

40. The apparatus of claim 39, wherein the MAC CE further comprises a transmission configuration indication (TCI) state associated with an IAB mobile terminal (IAB-MT) of the IAB node, and the processor causing the apparatus to determine is further based on the TCI state.
